(19) United States
(12) Patent Application Publication
(10) Pub. No.: US 2022/0394606 A1
(43) Pub. Date: Dec. 8, 2022

(54) Methods and Apparatus for Flexible Aggregation of Communications Channels

(71) Applicant: Huawei Technologies Co., Ltd., Shenzhen (CN)

(72) Inventor: Yunsong Yang, San Diego, CA (US)

(21) Appl. No.: 17/765,187

(22) PCT Filed: Oct. 3, 2019
(86) PCT No.: PCT/US2019/054456

§ 371 Date: Mar. 30, 2022

(51) Int. Cl. H04W 48/18; H04W 16/14

(52) U.S. Cl. CPC H04W 48/18; H04W 16/14; H04W 88/10

(57) ABSTRACT

A method includes configuring a first radio communications module (RCM) of an access point (AP) to serve a first transmitted basic service set (BSS) using a first BSS identifier (BSSID) and to serve a first non-transmitted BSS using a second BSSID, configuring a second RCM of the AP to serve a second transmitted BSS using the second BSSID and to serve a second non-transmitted BSS using the first BSSID, and transmitting a first set of data, a first subset of the first set of data being encapsulated in a first set of frames, the first set of frames being transmitted using the first RCM over a first shared channel, and a second subset of the first set of data being encapsulated in a second set of frames, the second set of frames being transmitted using the second RCM over a second shared channel.

### PRIORITY CLAIM

This application is a national phase filing under section 371 of PCT Application No. PCT/US2019/054456, filed on Oct. 3, 2019 and entitled “Methods and Apparatus for Flexible Aggregation of Communications Channels,” which is hereby incorporated by reference herein as if reproduced in its entirety.

### TECHNICAL FIELD

The present disclosure relates generally to methods and apparatus for digital communications, and, in particular embodiments, to methods and apparatus for flexible aggregation of communications channels.

### BACKGROUND

Carrier aggregation (CA) is a technique developed in the third generation partnership project (3GPP) Long Term Evolution (LTE) to increase available bandwidth, and hence, increase the available bitrate. Each aggregated carrier is referred to as a component carrier (CC). For a user equipment (UE) utilizing CA, there is one primary serving cell (PSC) operating on a primary CC (PCC), and there may be one or more secondary serving cells (SSCs), each SSC operating on a secondary CC (SCC). The coverage of different serving cells may differ due to the CCs operating on different frequency bands experiencing different pathlosses.

In 3GPP LTE CA, the radio resource control (RRC) connection of the UE is handled only by its PSC. Therefore, if the UE loses the connectivity with its PSC, the RRC connection of the UE will break down and so will the services that the UE is using, unless the UE uses over-the-air signaling to perform link failure recovery or handover procedures in order to connect with another PSC. Therefore, the PSC usually is chosen to be the serving cell with a reliable signal and usually operating on a CC with a large coverage area, e.g., a macro-cell.

Generally, SSCs only handle user data, therefore can be made of micro-cells and pico-cells, to boost up the user data rate and throughput. The infrastructure equipment (known as enhanced Node Bs or eNBs) serving the PSC needs to handle more signaling processing and therefore are generally more complex than the eNBs serving the SSCs. 3GPP has also developed solutions for aggregating LTE carrier(s) with a wireless local area network (WLAN) link, namely LTE-WLAN Aggregation (LWA) and LTE WLAN Radio Level Integration with IPsec Tunnel (LWIP). In both cases, the LTE serving cell, operating as the PSC, must be in control of the RRC connection for the UE. The WLAN link is used only for boosting the data rate and throughput of the UE. If the UE loses connectivity with the LTE serving cell (i.e., the PSC), then the RRC connection of the UE will be lost, and the aggregation of LTE and WLAN will also break down.

Therefore, there is a need for methods and apparatus for flexible aggregation of communications channels (also commonly referred to as carriers, links, etc.).

### SUMMARY

According to a first aspect, a method implemented by an access point (AP) is provided. The method includes configuring, by the AP, a first radio communications module (RCM) of the AP to serve a first transmitted basic service set (BSS) using a first BSS identifier (BSSID) and to serve a first non-transmitted BSS using a second BSSID, the second BSSID being different from the first BSSID, and the first RCM operating in a first shared channel, configuring, by the AP, a second RCM of the AP to serve a second transmitted BSS using the second BSSID and to serve a second non-transmitted BSS using the first BSSID, the second RCM operating in a second shared channel, the second shared channel and the first shared channel operating on different radio frequency carriers, and transmitting, by the AP, to a first station, a first set of data, a first subset of the first set of data being encapsulated in a first set of frames, the first set of frames being transmitted using the first RCM over the first shared channel, and a second subset of the first set of data being encapsulated in a second set of frames, the second set of frames being transmitted using the second RCM over the second shared channel.

In a first implementation form of the method according to the first aspect as such, further comprising determining, by the AP, that the first shared channel is unavailable, and based thereon, transmitting, by the AP, to the first station, a second set of data using the second RCM over the second shared channel.

In a second implementation form of the method according to the first aspect as such or any preceding implementation form of the first aspect, further comprising determining, by the AP, that the first shared channel is available, and based thereon, transmitting, by the AP, to the first station, a first subset of a third set of data using the first RCM over the first shared channel, and a second subset of the third set of data using the second RCM over the second shared channel.

In a third implementation form of the method according to the first aspect as such or any preceding implementation form of the first aspect, further comprising obtaining, by the AP, the first set of data from a first higher layer entity through a first media access control (MAC) service access point (M-SAP) of the first RCM, the first higher layer entity being above a first MAC entity of the first RCM and associated with the AP.

In a fourth implementation form of the method according to the first aspect as such or any preceding implementation form of the first aspect, further comprising generating, by the AP using the first MAC entity, the first set of frames to encapsulate the first subset of the first set of data and the second set of frames to encapsulate the second subset of the first set of data.

In a fifth implementation form of the method according to the first aspect as such or any preceding implementation form of the first aspect, each frame of the first and second sets of frames comprising a first MAC address of the first station in a receiver address (RA) field and the first BSSID in a transmitter address (TA) field.

In a sixth implementation form of the method according to the first aspect as such or any preceding implementation form of the first aspect, further comprising receiving, by the AP, from the first station, a fourth set of data, a first subset of the fourth set of data being encapsulated in a third set of frames, the third set of frames being received using the first RCM over the first shared channel, and a second subset of the fourth set of data being encapsulated in a fourth set of frames, the fourth set of frames being received using the second RCM over the second shared channel.

In a seventh implementation form of the method according to the first aspect as such or any preceding implementation form of the first aspect, further comprising processing, by the AP using the first MAC entity, the third and fourth sets of frames to recover the fourth set of data.

In an eighth implementation form of the method according to the first aspect as such or any preceding implementation form of the first aspect, further comprising delivering, by the AP, the fourth set of data to the first higher layer entity through the first M-SAP.

In a ninth implementation form of the method according to the first aspect as such or any preceding implementation form of the first aspect, each frame of the third and fourth sets of frames comprising the first BSSID in a RA field and the first MAC address of the first station in a TA field.

In a tenth implementation form of the method according to the first aspect as such or any preceding implementation form of the first aspect, further comprising transmitting, by the AP, to a second station, a fifth set of data, a first subset of the fifth set of data being encapsulated in a fifth set of frames, the fifth set of frames being transmitted using the first RCM over the first shared channel, and a second subset of the fifth set of data being encapsulated in a sixth set of frames, the sixth set of frames being transmitted using the second RCM over the second shared channel, and receiving, by the AP, from the second station, a sixth set of data, a first subset of the sixth set of data being encapsulated in a seventh set of frames, the seventh set of frames being received using the first RCM over the first shared channel, and a second subset of the sixth set of data being encapsulated in an eighth set of frames, the eighth set of frames being received using the second RCM over the second shared channel.

In an eleventh implementation form of the method according to the first aspect as such or any preceding implementation form of the first aspect, further comprising obtaining, by the AP, the fifth set of data from a second higher layer entity through a second M-SAP of the second RCM, the second higher layer entity being above a second MAC entity of the second RCM and associated with the AP, and generating, by the AP using the second MAC entity, the fifth set of frames to encapsulate the first subset of the fifth set of data and the sixth set of frames to encapsulate the second subset of the fifth set of data.

In a twelfth implementation form of the method according to the first aspect as such or any preceding implementation form of the first aspect, further comprising processing, by the AP using the second MAC entity, the seventh and eighth sets of frames to recover the sixth set of data, and delivering, by the AP, the sixth set of data to the second higher layer entity through the second M-SAP.

In a thirteenth implementation form of the method according to the first aspect as such or any preceding implementation form of the first aspect, each frame of the fifth and sixth sets of frames comprising a second MAC address of the second station in the RA field and the second BSSID in the TA field, and each frame of the seventh and eighth sets of frames comprising the second BSSID in the RA field and the second MAC address of the second station in the TA field.

According to a second aspect, a method implemented by a station is provided. The method includes associating, by the station, with a transmitted BSS of an AP using a first RCM of the station, the transmitted BSS being identified by a transmitted BSSID, and the first RCM operating in a first shared channel, communicating, by the station, with the AP using the first RCM, to configure a second RCM of the station, the second RCM operating in a second shared channel, the second shared channel and the first shared channel operating on different radio frequency carriers, transmitting, by the station, to the AP, a first set of data, a first subset of the first set of data being encapsulated in a first set of frames, the first set of frames being transmitted using the first RCM over the first shared channel, and a second subset of the first set of data being encapsulated in a second set of frames, the second set of frames being transmitted using the second RCM over the second shared channel, and receiving, by the station, from the AP, a second set of data, a first subset of the second set of data being encapsulated in a third set of frames, the third set of frames being received using the first RCM over the first shared channel, and a second subset of the second set of data being encapsulated in a fourth set of frames, the fourth set of frames being received using the second RCM over the second shared channel.

In a first implementation form of the method according to the second aspect as such, further comprising obtaining, by the station, the first set of data from a higher layer entity of the station through a M-SAP of the first RCM, and generating, by the station using a MAC entity of the first RCM, the first set of frames to encapsulate the first subset of the first set of data and the second set of frames to encapsulate the second subset of the first set of data.

In a second implementation form of the method according to the second aspect as such or any preceding implementation form of the second aspect, further comprising processing, by the station using the MAC entity of the first RCM, the third and fourth sets of frames to recover the second set of data, and delivering, by the station, the second set of data to the higher layer entity through the M-SAP of the first RCM.

In a third implementation form of the method according to the second aspect as such or any preceding implementation form of the second aspect, each frame of the first and second sets of frames comprising a MAC address of the station in a RA field and the transmitted BSSID in a TA field, and each frame of the third and fourth sets of frames comprising the transmitted BSSID in the RA field and the MAC address of the station in the TA field.

According to a third aspect, an AP is provided. The AP includes a non-transitory memory storage comprising instructions, and one or more processors in communication with the memory storage, the one or more processors executing the instructions to configure a first RCM of the AP to serve a first transmitted BSS using a first BSSID and to serve a first non-transmitted BSS using a second BSSID, the second BSSID being different from the first BSSID, and the first RCM operating in a first shared channel, configure a second RCM of the AP to serve a second transmitted BSS using the second BSSID and to serve a second non-transmitted BSS using the first BSSID, the second RCM operating in a second shared channel, the second shared channel and the first shared channel operating on different radio frequency carriers, and transmit, to a first station, a first set of data, a first subset of the first set of data being encapsulated in a first set of frames, the first set of frames being transmitted using the first RCM over the first shared channel, and a second subset of the first set of data being encapsulated in a second set of frames, the second set of frames being transmitted using the second RCM over the second shared channel.

In a first implementation form of the AP according to the third aspect as such, the one or more processors further executing the instructions to determine that the first shared channel is unavailable, and based thereon, transmit, to the first station, a second set of data using the second RCM over the second shared channel.

In a second implementation form of the AP according to the third aspect as such or any preceding implementation form of the third aspect, the one or more processors further executing the instructions to determine that the first shared channel is available, and based thereon, transmit, to the first station, a first subset of a third set of data using the first RCM over the first shared channel, and a second subset of the third set of data using the second RCM over the second shared channel.

In a third implementation form of the AP according to the third aspect as such or any preceding implementation form of the third aspect, the one or more processors further executing the instructions to obtain the first set of data from a first higher layer entity through a first M-SAP of the first RCM, the first higher layer entity being above a first MAC entity of the first RCM and associated with the AP.

In a fourth implementation form of the AP according to the third aspect as such or any preceding implementation form of the third aspect, the one or more processors further executing the instructions to receive, from the first station, a fourth set of data, a first subset of the fourth set of data being encapsulated in a third set of frames, the third set of frames being received using the first RCM over the first shared channel, and a second subset of the fourth set of data being encapsulated in a fourth set of frames, the fourth set of frames being received using the second RCM over the second shared channel.

In a fifth implementation form of the AP according to the third aspect as such or any preceding implementation form of the third aspect, the one or more processors further executing the instructions to transmit, to a second station, a fifth set of data, a first subset of the fifth set of data being encapsulated in a fifth set of frames, the fifth set of frames being transmitted using the first RCM over the first shared channel, and a second subset of the fifth set of data being encapsulated in a sixth set of frames, the sixth set of frames being transmitted using the second RCM over the second shared channel, and receive, from the second station, a sixth set of data, a first subset of the sixth set of data being encapsulated in a seventh set of frames, the seventh set of frames being received using the first RCM over the first shared channel, and a second subset of the sixth set of data being encapsulated in an eighth set of frames, the eighth set of frames being received using the second RCM over the second shared channel.

In a sixth implementation form of the AP according to the third aspect as such or any preceding implementation form of the third aspect, the one or more processors further executing the instructions to obtain the fifth set of data from a second higher layer entity through a second M-SAP of the second RCM, the second higher layer entity being above a second MAC entity of the second RCM and associated with the AP, and generate, using the second MAC entity, the fifth set of frames to encapsulate the first subset of the fifth set of data and the sixth set of frames to encapsulate the second subset of the fifth set of data.

In a seventh implementation form of the AP according to the third aspect as such or any preceding implementation form of the third aspect, the one or more processors further executing the instructions to process, using the second MAC entity, the seventh and eighth sets of frames to recover the sixth set of data, and deliver the sixth set of data to the second higher layer entity through the second M-SAP.

According to a fourth aspect, a station is provided. The station includes a non-transitory memory storage comprising instructions, and one or more processors in communication with the memory storage, the one or more processors executing the instructions to associate with a transmitted BSS of an AP using a first RCM of the station, the transmitted BSS being identified by a transmitted BSSID, and the first RCM operating in a first shared channel, communicate, with the AP using the first RCM, to configure a second RCM of the station, the second RCM operating in a second shared channel, the second shared channel and the first shared channel operating on different radio frequency carriers, transmit, to the AP, a first set of data, a first subset of the first set of data being encapsulated in a first set of frames, the first set of frames being transmitted using the first RCM over the first shared channel, and a second subset of the first set of data being encapsulated in a second set of frames, the second set of frames being transmitted using the second RCM over the second shared channel, and receive, from the AP, a second set of data, a first subset of the second set of data being encapsulated in a third set of frames, the third set of frames being received using the first RCM over the first shared channel, and a second subset of the second set of data being encapsulated in a fourth set of frames, the fourth set of frames being received using the second RCM over the second shared channel.

In a first implementation form of the station according to the fourth aspect as such, the one or more processors further executing the instructions to obtain the first set of data from a higher layer entity of the station through a M-SAP of the first RCM, and generate, using a MAC entity of the first RCM, the first set of frames to encapsulate the first subset of the first set of data and the second set of frames to encapsulate the second subset of the first set of data.

In a second implementation form of the station according to the fourth aspect as such or any preceding implementation form of the fourth aspect, the one or more processors further executing the instructions to process, using the MAC entity of the first RCM, the third and fourth sets of frames to recover the second set of data, and deliver the second set of data to the higher layer entity through the M-SAP of the first RCM.

In a third implementation form of the station according to the fourth aspect as such or any preceding implementation form of the fourth aspect, each frame of the first and second sets of frames comprising a MAC address of the station in a RA field and the transmitted BSSID in a TA field, and each frame of the third and fourth sets of frames comprising the transmitted BSSID in the RA field and the MAC address of the station in the TA field.

An advantage of a preferred embodiment is that restrictions on the selection of a master channel, over which two multi-channel or multi-link (ML) capable devices may perform the initial association and authentication with each other, and configure the ML operations between them, are removed (e.g., the master channel doesn't have to be the channel that has the largest coverage among all component channels of the ML).

Yet another advantage of a preferred embodiment is that there is a reduction in the need to immediately change the master channel in certain situations, so as to allow smooth roaming, easy upgrade or downgrade of the ML configuration, and service continuity when any channel of the ML experiences a temporary or semi-permanent loss of connectivity.

Practice of the foregoing embodiments also facilitates load balancing among the multiple channels.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1A illustrates an example communications system consisting of an infrastructure BSS;

FIG. 1B illustrates an example 802.11 network with devices communicating over aggregated shared channels;

FIG. 2 illustrates a communications system highlighting a multi-link (ML)-capable AP device and an ML-capable non-AP STA device communicating with one another;

FIG. 3 illustrates a communications system highlighting example block diagrams of an ML-AP device communicating with two ML-STA devices using multiple contention based 802.11 communications channels according to example embodiments presented herein;

FIG. 4 illustrates a block diagram of a first example de-multiplexing (DEMUX)/multiplexing (MUX) unit according to example embodiments presented herein;

FIG. 5 illustrates a block diagram of a second example DEMUX/MUX unit according to example embodiments presented herein;

FIG. 6 illustrates an example procedure for configuring the ML operations according to example embodiments presented herein;

FIG. 7 illustrates an example communications system highlighting the flexible aggregation of multiple channels, where an ML-STA device roams without changing the master channel according to example embodiments presented herein;

FIG. 8 illustrates an example communications system highlighting the flexible aggregation of multiple channels, where service is maintained after loss of a shared channel according to example embodiments presented herein;

FIG. 9 illustrates a block diagram of an example DEMUX/MUX unit of a device, highlighting the movement of protocol data units (PDUs) through the DEMUX/MUX unit resulting from a failed master channel according to example embodiments presented herein;

FIG. 10 illustrates an example communications system highlighting the flexible aggregation of multiple channels, where load balancing is utilized when serving ML-STA devices according to example embodiments presented herein;

FIG. 11 illustrates a flow diagram of example operations occurring in an ML device sending data according to example embodiments presented herein;

FIG. 12 illustrates a flow diagram of example operations occurring in an ML device receiving data according to example embodiments presented herein;

FIG. 13 illustrates an example communication system according to example embodiments presented herein;

FIGS. 14A and 14B illustrate example devices that may implement the methods and teachings according to this disclosure; and

FIG. 15 is a block diagram of a computing system that may be used for implementing the devices and methods disclosed herein.

### DETAILED DESCRIPTION OF ILLUSTRATIVE EMBODIMENTS

The structure and use of disclosed embodiments are discussed in detail below. It should be appreciated, however, that the present disclosure provides many applicable concepts that can be embodied in a wide variety of specific contexts. The specific embodiments discussed are merely illustrative of specific structure and use of embodiments, and do not limit the scope of the disclosure.

The Institute of Electrical and Electronic Engineers (IEEE) Standard 802.11-2016 is a set of media access control (MAC) layer and physical (PHY) layer specifications for implementing Wi-Fi communications in the 2.4, 5, 6, and 60 GHz frequency bands. A basic service set (BSS) provides the basic building-block of an 802.11 wireless LAN. In an infrastructure mode of 802.11, a single access point (AP) together with all associated stations (STAs) form a BSS. The AP acts as a master to control the STAs within that BSS. A station (STA) may also be referred to as a device, a user equipment, a terminal, a node, and so forth. An AP may also be referred to as a network controller, a base station, a wireless router (due to a router co-located with the AP, the router providing a connection to a network), and so on. The simplest infrastructure BSS consists of one AP and one STA.

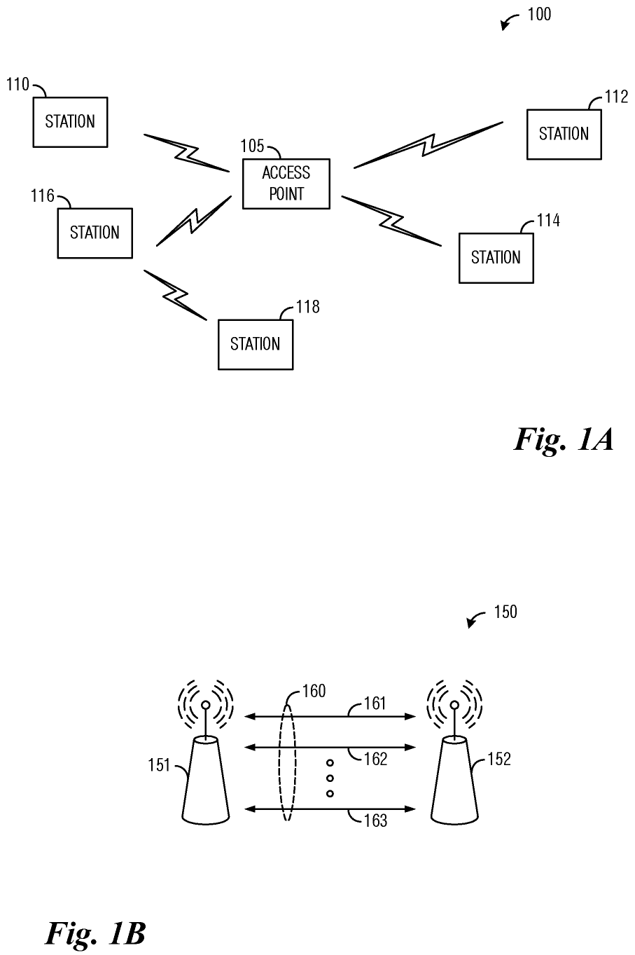

FIG. 1A illustrates an example communications system 100 consisting of an infrastructure BSS. Communications system 100 includes an AP 105 that is serving a plurality of stations, such as STAs 110, 112, 114, 116, and 118. Access point 105 controls certain aspects (such as radio frequency channel, transmission power limit, authentication, security, etc.) of communications with or among its associated stations. Generally speaking, in communications system 100, wireless resources for both uplink (STA to AP) and downlink (AP to STA) transmissions are accessed by transmitters based on a distributed contention mechanism commonly referred to as carrier sensing multiple access with collision avoidance (CSMA/CA). However, AP 105 still may influence the access to the shared wireless media (WM) by assigning different access priorities to different STAs or different types of traffic streams. Shared WM may also be referred to as shared channel, shared link, shared medium, etc.

FIG. 1B illustrates an example 802.11 network 150 with devices communicating over aggregated shared channels. Network 150 includes devices, including device 151 and device 152, communicating over an aggregated shared channel 160. The devices may be APs, STAs, or a combination of AP and STA. Aggregated shared channel 160 comprises a plurality of shared channel (e.g, 802.11 shared channel), including shared channel 161, 162, and 163. As referred to herein, a shared channel is different from another shared channel when the channels are established over different radio frequencies.

Modern wireless fidelity (Wi-Fi) devices increasingly support multi-band capability. For example, it is common that Wi-Fi APs and STAs support 2.4 and 5 GHz dual-band. Also, some devices are tri-band, capable of operating on 2.4, 5, and 60 GHz bands. The IEEE 802.11 Task Group be (TGbe), whose predecessor is known as Extremely High Throughput Study Group (EHT SG), has accepted lower latency, lower jitters, and lower packet loss as part of their work scope, in addition to extremely high throughput, as suggested by the name of the study group. The need for higher throughput is driven by demand for video at 4K or higher resolutions and the need for lower latency and jitters is driven by applications such as gaming, industrial control, and augmented reality.

The demand for these newer services can be addressed by aggregating multiple links operating on different radio frequency (RF) carriers that may be within a same RF band or from different RF bands, for communicating data between devices. Details of exchanging data by utilizing multi-channel or multi-link (ML) aggregation techniques have been described in the co-pending and co-assigned PCT application PCT/US19/39038, entitled “System and Method for Aggregating Communications Links”, and filed on Jun. 25, 2019, which is hereby incorporated herein by reference in its entirety.

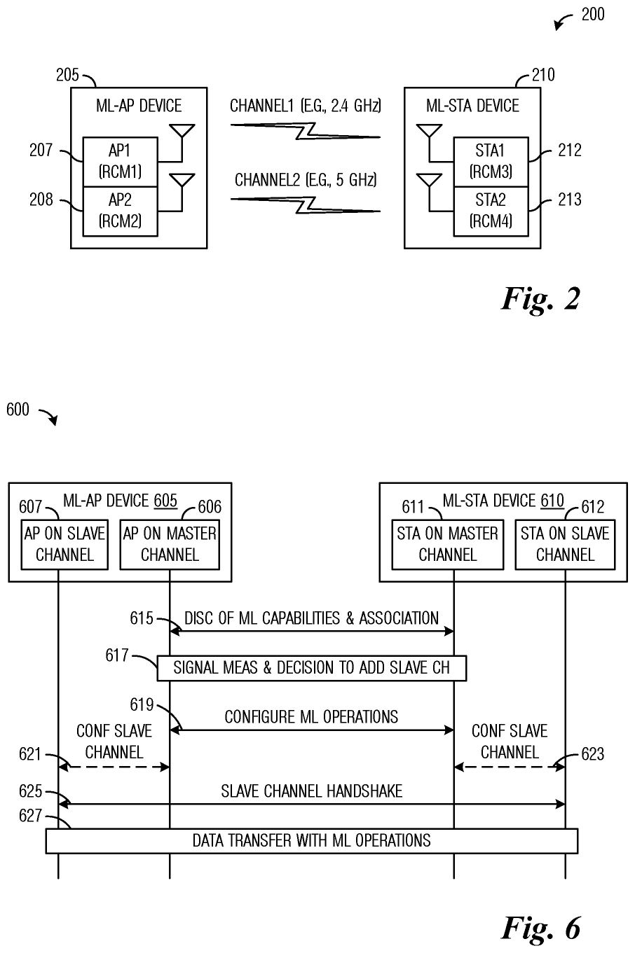

FIG. 2 illustrates a communications system 200 highlighting an ML-capable AP device 205 and an ML-capable non-AP STA device 210 communicating with one another. ML-capable AP device 205, as a whole, is referred to as an ML-AP device, and ML-capable non-AP STA device 210, as a whole, is referred to as an ML-STA device, to avoid confusion with individual component APs or STAs within. The ML-AP device 205 and the ML-STA device 210 may be seen as union of multiple co-located APs (e.g., AP1 207 and AP2 208) and STAs (e.g., STA1 212 and STA2 213), respectively, with each pair of AP and STA operating on a different RF carrier. Individually, AP1 207 and AP2 208, and STA1 212 and STA2 213, may also be visualized as different radio communications modules (RCMs) of the ML-AP device 205 and the ML-STA device 210, respectively. There is at least one traffic stream between the ML-AP device 205 and ML-STA device 210 that is configured to utilize ML aggregation techniques in exchanging data over that traffic stream. Such a traffic stream is referred to as an ML traffic stream.

According to an example embodiment, methods and apparatus are provided for aggregating multiple contention-based 802.11 channels for data communications in order to prevent the restriction on the selection of the primary serving cell (PSC) and the issues associated with losing the connectivity with the PSC from being repeated in the ML aggregation technique being developed by IEEE 802.11 TGbe. These restrictions and issues are present in the third generation partnership project (3GPP) Long Term Evolution (LTE) carrier aggregation (CA), for example. In accordance with these methods and apparatus, any channel of the ML may be configured as the master channel for exchanging data in an ML traffic stream between a pair of ML devices, while being simultaneously configured as a slave channel for serving another ML traffic stream between the same pair of ML devices or a different pair of ML devices.

As an example, two ML devices may begin their communications over a channel of the ML, e.g., for discovering each other, exchanging capabilities information (including ML aggregation related capabilities, etc.), establishing an association between the two devices, performing authentication and 4-way handshake to install shared secret keys for providing data confidentiality or integrity protection, and so on. That channel may be designated as the master channel between the two ML devices. The RCMs of the ML devices used in forming the master channel for an ML traffic stream are referred to as the master RCMs of that ML traffic stream. Data transmission using ML aggregation is enabled when one or more additional channels, referred to as slave channel(s), are added. The sequence of data of the ML traffic stream is processed by media access control (MAC) layer entities of the master RCMs of both ML devices, and may be transmitted or received over either the master channel, the slave channel(s), or both master and slave channels, using the physical (PHY) layer entities of the master RCMs or slave RCMs of both ML devices, respectively. A de-multiplexing/multiplexing (DEMUX/MUX) unit, located across the ML and between the MAC and PHY layer entities of both ML devices, performs channel selection and frame forwarding during the transmitting, and frame filtering and forwarding during the receiving.

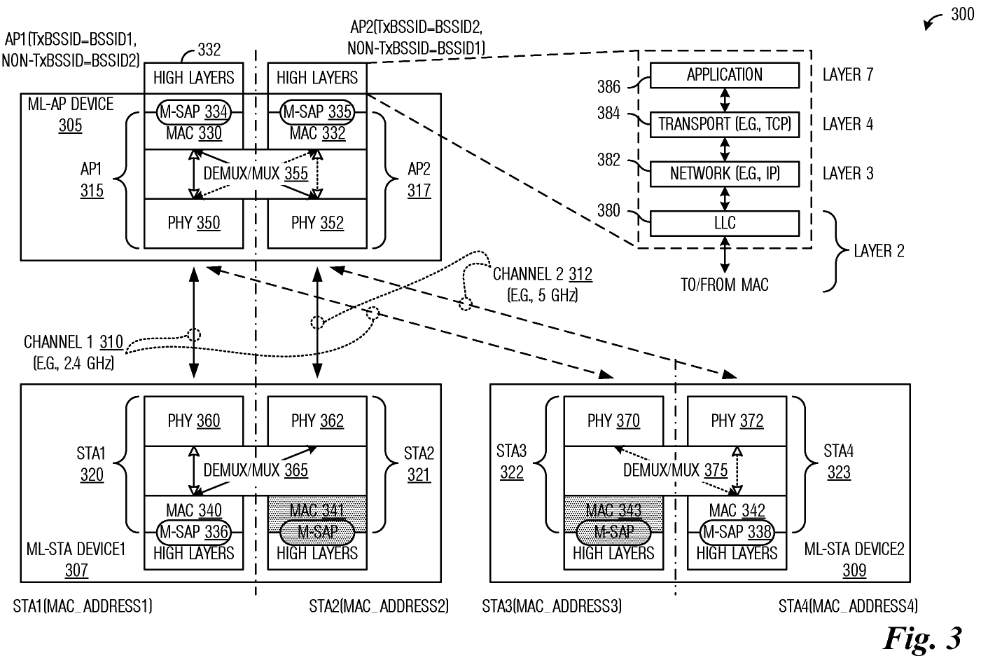

FIG. 3 illustrates a communications system 300 highlighting example block diagrams of an ML-AP device 305 communicating with two ML-STA devices 307 and 309 using multiple contention based 802.11 communications channels (or simply shared channels). As shown in FIG. 3, there are two shared channel, shared channel 1310 and shared channel 2 312, between the ML-AP device 305 and the two ML-STA devices, ML-STA device 1307 and ML-STA device 2 309. Shared channel 1310 and shared channel 2 312 are shared wireless channels or media, e.g., within 2.4 GHz band and 5 GHz band, respectively. There are sufficient frequency gap between shared channel 1310 and shared channel 2312 such that they can be used for simultaneous transmissions in different directions without causing interference with one another. Although illustrated in FIG. 3 as being an AP and two STAs, the devices may be peer devices operating in a peer-to-peer (P2P) or ad-hoc communications mode.

The ML-AP device 305 comprises AP1 315 and AP2 315. AP1 315 operates on shared channel 1310 and serves two BSSs by serving a transmitted BSS with a BSS identifier (BSSID) equal to BSSID1 and a non-transmitted BSS with a BSSID equal to BSSID2. AP2 317 operates on shared channel 2 312 and serves two BSSs by serving a transmitted BSS with a BSSID equal to BSSID2 and a non-transmitted BSS with a BSSID equal to BSSID1.

ML-STA device 1307 comprises STA1320 and STA2321 operating on shared channel 1310 and shared channel 2312, respectively. STA1320 and STA2 321 are identified with the MAC addresses equal to MAC_Address1 and MAC_Address2, respectively. ML-STA device 2 309 comprises STA3 322 and STA4 323 operating on shared channel 1310 and shared channel 2 312, respectively. STA3 322 and STA4 323 are identified with the MAC addresses equal to MAC_Address3 and MAC_Address4, respectively.

As shown in FIG. 3, ML-STA device 1307 initially uses STA1320 to perform association and mutual authentication with the transmitted BSS of AP1 315 over shared channel 1310 and to install the shared security keys. After the association, AP2 317 (using its non-transmitted BSS with BSSID1) and STA2 321 are configured to add shared channel 2 312 to the ML configuration of ML-STA device 1307 to enable the ML transmission for an ML traffic stream of ML-STA device 1307. Therefore, shared channel 1310 and shared channel 2 312 are the master channel and a slave channel for the ML traffic stream of ML-STA device 1307, respectively. STA1320 and STA2321 are the master RCM and a slave RCM of ML-STA device 1 307 for the ML traffic stream of ML-STA device 1307, respectively. AP1 315 and AP2 317 are the master RCM and a slave RCM, respectively, on the ML-AP device 305 side, for the ML traffic stream of ML-STA device 1307.

As also shown in FIG. 3, ML-STA device 2 309 initially uses STA4 323 to perform association and mutual authentication with the transmitted BSS of AP2 317 over shared channel 2 312 and to install the shared security keys. After the association, AP1 315 (using its non-transmitted BSS with BSSID2) and STA3 322 are configured to add shared channel 1310 to the ML configuration of ML-STA device 2 309 to enable the ML transmission for an ML traffic stream of ML-STA device 2 309. Therefore, shared channel 2 312 and shared channel 1310 are the master channel and a slave channel for the ML traffic stream of ML-STA device 2 309, respectively. STA4 323 and STA3 322 are the master RCM and a slave RCM of ML-STA device 2 309 for the ML traffic stream of ML-STA device 2 309, respectively. AP2 317 and AP1 315 are the master RCM and a slave RCM, respectively, on the ML-AP device 305 side, for the ML traffic stream of ML-STA device 2 309.

Hence, AP1 315 and AP2 317 serve as the master RCM and slave RCM, respectively, for the ML traffic stream of ML-STA device 1307, while they serve as the slave RCM and master RCM, respectively, for the ML traffic stream of ML-STA device 2 309. The ML configuration may be performed on a basis of per ML-STA device, or per traffic stream (therefore, even different ML traffic streams of a single ML-STA device may have different ML configurations). Shared channel 1310 and shared channel 2312 refer to the shared communications channels operating over different radio frequencies. Master channel and slave channel are also used to refer to the multi-links, but with emphasis being placed on the logical role that the channel plays in the ML operations.

In addition to serving as part of the master channel for the ML traffic streams of ML-STA devices, the transmitted BSS of both AP1 315 and AP2 317 may also serve traffic streams of associated non-ML STAs, e.g., legacy STAs, or concurrent non-ML traffic streams of associated ML-STA devices, in a same manner as a normal BSS. A non-ML traffic stream is a traffic stream where the data is transmitted using a single channel, as in legacy 802.11 communication systems.

An ML-STA device may concurrently have ML and non-ML traffic streams when there are multiple applications with different QoS requirements simultaneously executing on the ML-STA device. For example, ML-STA device 1307 in FIG. 3 may simultaneously have an interactive gaming application and an e-mail application running. The interactive gaming application (due to its more restrictive QoS requirement) is configured with an ML traffic stream, while the e-mail application (being delay insensitive) is configured with a non-ML traffic stream. Therefore, the data of the interactive gaming application is communicated using the ML operation involving shared channel 1310 and shared channel 2 312, while the data of the e-mail application may be communicated between ML-STA device 1307 and the ML-AP device 305 using a single channel. That single channel may be shared channel 1310 by using STA1320 and the transmitted BSS of AP1 315, or shared channel 2 312 by using STA2321 and the transmitted BSS of AP2 317. In the case where shared channel 2 312 is used, a separate association between STA2321 and the transmitted BSS of AP2 317 is established.

In order to simplify the frame forwarding rules, the non-transmitted BSS of AP1 315 with the BSSID equal to BSSID2 and the non-transmitted BSS of AP2 317 with the BSSID equal to BSSID1 are not used for serving non-ML STAs or non-ML traffic streams, e.g., in the DEMUX/MUX unit, which will be described later. However, AP1 315 and AP2 317 may use additional non-transmitted BSSs with a different BSSIDs, e.g., with BSSID3 and BSSID4, respectively, to support the conventional virtual BSS functions.

Data of the ML traffic stream are obtained from the higher layer entity (such as higher layer entity 332 (e.g., the logical link control (LLC) sub-layer)), for the transmitting, and are delivered to the higher layer entity, for the receiving, by the MAC entity of the master RCMs. For example, data of the ML traffic stream associated with ML-STA device 307 enters or exits ML-AP device 305 (from or to associated LLC sub-layer) through the MAC service access point (M-SAP) 334 of AP1 315, and exits or enters ML-STA device 307 (to or from associated LLC sub-layer) through M-SAP 336 of STA1320, while data of the ML traffic stream associated with ML-STA device 309 enters or exits ML-AP device 305 (from or to associated LLC sub-layer) through M-SAP 335 of AP2 317, and exits or enters ML-STA device 309 (to or from associated LLC sub-layer) through M-SAP 338 of STA4 323.

In an embodiment, frames associated with the ML traffic stream, such as the data frames encapsulating data of the ML traffic stream, the management frames and control frames related to the data operations of the ML traffic stream, etc., are generated (during the transmitting) and processed (during the receiving) by the MAC entity of the transmitting and receiving RCMs operating on the master channels (i.e., the master RCMs), respectively, no matter the frames are transmitted or received over shared channel 1310 or shared channel 2 312.

As an example, as related to frames associated with the ML traffic stream of ML-STA device 1307, when the frames are sent from ML-STA device 1307 to the ML-AP device 305, the frames are formed by the MAC entity 340 of STA1320 with BSSID1 and MAC_Address1 being included in the receiver address (RA) field and the transmitter address (TA) field in the MAC header of the frames, respectively. The RA field is used for identifying the intended receiving STA. The TA field is used for identifying the transmitting STA. When the frames are sent from the ML-AP device 305 to ML-STA device 1307, the frames are formed by the MAC entity 330 of AP1 305 with MAC_Address1 and BSSID1 being included in the RA field and the TA field in the MAC header of the frames, respectively. When data confidentiality or integrity protection is required, these frames are encrypted or integrity-protected using the shared security key established by AP1 315 and STA1320.

As another example, as related to frames associated with the ML traffic stream of ML-STA device 2 309, when the frames are sent from ML-STA device 2 309 to the ML-AP device 305, the frames are formed by the MAC entity 342 of STA4 323 with BSSID2 and MAC_Address4 being included in the RA field and the TA field in the MAC header of the frames, respectively. When the frames are sent from the ML-AP device 305 to ML-STA device 2 309, the frames are formed by the MAC entity 332 of AP2 with MAC_Address4 and BSSID2 being included in the RA field and the TA field in the MAC header of the frames, respectively. When data confidentiality or integrity protection is required, these frames are encrypted or integrity-protected using the shared security key established by AP2 317 and STA4 323.

The MAC entities 341 and 343, and corresponding M-SAPs of STA2 321 and STA3 322 (shown as shaded areas in FIG. 3), are not used for their respective ML traffic streams in the examples discussed herein. However, in a different example scenario, the MAC entity 341 and M-SAP of STA2 321 may be used for a concurrent traffic stream of ML-STA device 1307, with the concurrent traffic stream being a non-ML traffic stream served through shared channel 2 312. Alternatively, in yet another example scenario, the MAC entity 341 and M-SAP of STA2 321 may also be used when the concurrent traffic stream is another ML traffic stream but with shared channel 2 312 operating as the master channel (therefore, AP2 317 and STA2 321 operating as the master RCMs) and shared channel 1310 serving as the slave channel (therefore, AP1 315 and STA1320 operating as slave RCMs).

In an embodiment, the PHY entities of AP1 315 (i.e., PHY entity 350) and AP2 317 (i.e., PHY entity 352), when receiving a PHY protocol data unit (PPDU) with the PHY header containing a partial BSSID (PBSSID) matching a PBSSID that is generated from either BSSID1 or BSSID2, forward the PHY payload (i.e., the frame) of the PPDU to the DEMUX/MUX unit 355 above them. This operation may be facilitated by AP1 315 and AP2 317 supporting multiple BSSIDs with BSSID1 and BSSID2 being their transmitted and non-transmitted BSSIDs (for AP1 315) and vice versa (for AP2 317). Alternatively, this operation may be facilitated by the PHY entities 350 and 352 of AP 315 and AP2 317, respectively, being configured (e.g., via a PHYCONFIG_VECTOR primitive) to accept both partial BSSIDs generated from BSSID1 and BSSID2 without using the multiple BSSIDs feature.

In an embodiment, the PHY entities 360 and 362 of STA1 320 and STA2 321, respectively, when receiving a PPDU intended for STA1 320, forward the PHY payload (i.e., the frame) in the PPDU to the DEMUX/MUX unit 365 above them. This operation may be facilitated by the PHY entity 362 of STA2 321 being configured (e.g., via a PHYCONFIG_VECTOR primitive) to also accept, in addition to the partial association identifier (AID) assigned to STA2 321 by AP2 317 if there is an association between STA2 321 and AP2 317, the partial AID assigned to STA1 320 by AP 315. Alternatively, this operation may be facilitated by the PHY entity 362 of STA2 321 not performing the optional PPDU filtering based on partial AID. By similar a mechanism, the PHY entities 370 and 372 of STA3 322 and STA4 323, respectively, when receiving a PPDU intended for STA4 323, forward the PHY payload (i.e., the frame) in the PPDU to the DEMUX/MUX unit 375 above them.

In an embodiment, the DEMUX/MUX unit 355 added across both shared channel 1 310 and shared channel 2312 between MAC entity 330 and PHY entity 350 of AP1 315 and between MAC entity 332 and PHY entity 352 of AP2 317, the DEMUX/MUX unit 365 added across both shared channel 1310 and shared channel 2312 between MAC entity 340 and PHY entity 360 of STA1 320 and between MAC entity 341 and PHY entity 362 of STA2321, and the DEMUX/MUX unit 375 added across both shared channel 1310 and shared channel 2 312 between MAC entity 343 and PHY entity 370 of STA3 322 and between MAC entity 342 and PHY entity 372 of STA4 323, respectively perform channel selection and frame forwarding during the transmitting and frame filtering and forwarding during the receiving.

As shown in FIG. 3, the higher layer entities above the ML-AP device 305, ML-STA device 1307, and ML-STA device 2 309 may include a LLC sub-layer entity 380, which sub-layer, together with the MAC sub-layer, corresponds to the data link layer (also referred to as Layer 2) in the Open Systems Interconnection (OSI) model, a network layer (also referred to as Layer 3) entity 382, a transport layer (also referred to as Layer 4) entity 384, and an application layer (also referred to as Layer 7) entity 386. Although the details of the higher layer entities are presented in FIG. 3 for AP2 317, similar higher layer entities are present for other STAs. A commonly used protocol in the network layer is the internet protocol (IP). Commonly used protocols in the transport layer include the transmission control protocol (TCP) and user datagram protocol (UDP). For ML-STA device 1307 and 2 309, as client devices (e.g., a mobile phone), the higher layers entities above the respective MAC entities are also usually co-located with the ML devices. On the other hand, the higher layers entities above the ML-AP device 305 may not all be co-located with the infrastructure ML device. For example, the application layer and transport layer above the ML-AP device 305 may be implemented at a network server that is remote from the local area network (LAN) where the ML-AP device 305 and the ML-STA devices 307 and 309 are situated. Furthermore, the network layer may be implemented at two gateways that are located in the same LANs as the infrastructure ML device and the network server hosting the application, respectively, and at a number of routers situated along the data-transmission path between the two gateways.

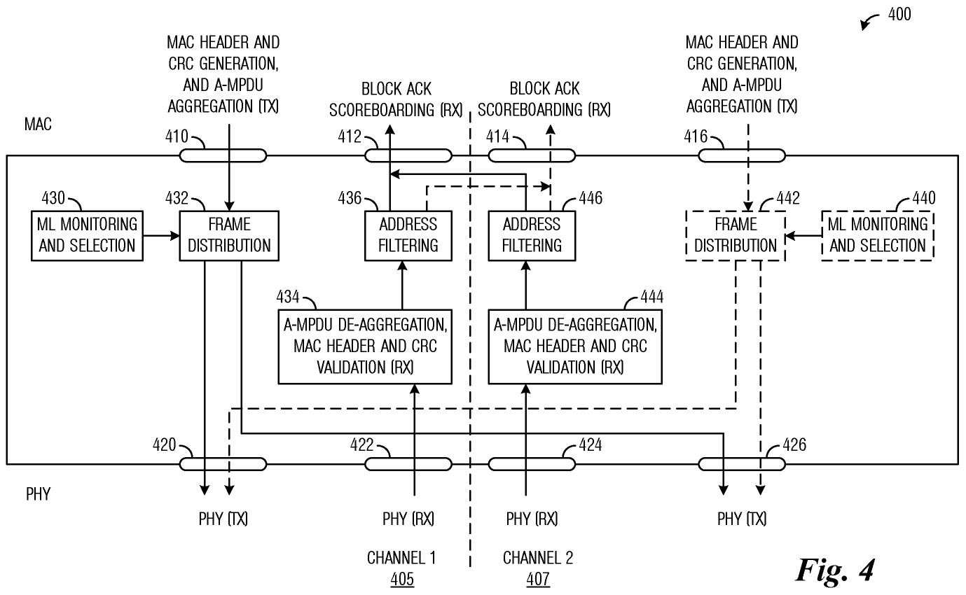

FIG. 4 illustrates a block diagram of a first example DEMUX/MUX unit 400. DEMUX/MUX unit 400 may be an example embodiment of DEMUX/MUX unit 355 in the ML-AP device 305 of FIG. 3. Although, only two channels (denoted as channel 1405 and channel 2 407) are shown in FIG. 4, DEMUX/MUX unit 400 may provide the distribution and aggregation functions for more than two channels. As shown in FIG. 4, DEMUX/MUX unit 400 includes interfaces 410 and 416 interfacing with the transmitting (TX) paths (e.g., the MAC Header and CRC Creation and A-MPDU Aggregation unit) of the MAC entities of the RCMs operating on channels 1405 and 2 407, respectively, for obtaining frames generated by the respective MAC entity. DEMUX/MUX unit 400 also includes interfaces 412 and 414 interfacing with the receiving (RX) paths (e.g., the Block Ack Scoreboarding unit) of the MAC entities of the RCMs operating on channels 1405 and 2 407, respectively, for delivering frames received by the PHY entities of both RCMs and intended for the respective MAC entity, as well as interfaces 420 and 426 interfacing with the TX paths of the PHY entities of the RCMs operating on channels 1 405 and 2 407, respectively, for delivering frames to the selected PHY entities for transmission. DEMUX/MUX unit 400 further includes interfaces 422 and 424 interfacing with the RX paths of the PHY entities of the RCMs operating on channels 1405 and 2 407, respectively, for obtaining frames received by these PHY entities. Additionally, DEMUX/MUX unit 400 includes ML Monitoring and Selection units 430 and 440, Frame Distribution units 432 and 442, A-MPDU De-aggregation and MAC Header and CRC Validation units 434 and 444, and Address Filtering units 436 and 446.

When channel 1405 is used as the master channel for an ML-STA device, in the transmitting direction (shown with downward solid-line arrows), a sequence of frames generated by the MAC entity (such as MAC entity 330) of the RCM operating on channel 1 (the master RCM) enters DEMUX/MUX unit 400 via interface 410. ML Monitoring and Selection unit 430 selects one channel (or more than one channel for redundancy purposes) from the multiple channels, over which a next frame is to be transmitted. In an embodiment, ML Monitoring and Selection unit 430 may prioritize a frame to be the next frame in the queue to be transmitted. For example, a frame to be re-transmitted may have a higher priority to be the next frame in the queue. For another example, a frame encapsulating a higher layer response, e.g., a TCP ACK, may have a higher priority to be the next frame in the queue. Frames encapsulating a TCP ACK may be recognized by a predefined fixed size of the TCP ACK, for example. MPDU Distribution unit 432 forwards the next frame to the PHY entity of the RCM of the selected channel (such as PHY entity 350 or 352).

In the receiving direction (shown with upward solid-line arrows), frames received over the multiple channels enter DEMUX/MUX unit 400 via interface 422 if received over channel 1405, or via interface 424 if received over the channel 2 407. Then, A-MPDU De-aggregation and MAC Header and CRC Validation units 434 and 444 perform A-MPDU and MAC header and CRC validation on the frames received over their respective channels to ensure that the frames received are valid frames. Then, Address Filtering units 436 and 446 may perform frame filtering based on the MAC address(es) in the MAC header of the received frames. For example, the frame filtering may be based on a value in the RA field in the MAC header matching the MAC address of the receiving master RCM. Alternatively, the frame filtering may be based on a value in the TA field in the MAC header matching the MAC address of the transmitting master RCM, with which the receiving master RCM has configured the channel aggregation for the ML traffic stream. Yet alternatively, the frame filtering may be based on both the RA and TA values being matched.

In an embodiment, during transmitting, when the DEMUX/MUX unit of ML-AP device receives a frame associated with an ML traffic stream from the MAC entity of AP1 or AP2 for transmission, the DEMUX/MUX unit selects a channel and forwards the frame to the PHY of the RCM operating on that channel. A frame not associated with ML traffic stream passes through the DEMUX/MUX unit and goes directly to the PHY entity of the same RCM as the MAC entity that is generating the frame. Then, the PHY entity of that RCM adds PHY header to the frame to form a PPDU for transmission.

In an embodiment, during receiving, PHY entities of AP1 and AP2 pass on frames in the received PPDUs to the DEMUX/MUX unit above them. The DEMUX/MUX unit of ML-AP device filters the received frames based on the RA (also known as Address 1 or A1) field in the frame, thus forwards frames associated with the ML traffic stream of ML-STA device 1 to the MAC entity (such as MAC entity 330) of AP1 because the A1 in the frames is equal to BSSID1, and frames associated with the ML traffic stream of ML-STA device 2 to the MAC entity (such as MAC entity 332) of AP2 because the A1 in the frames is equal to BSSID2.

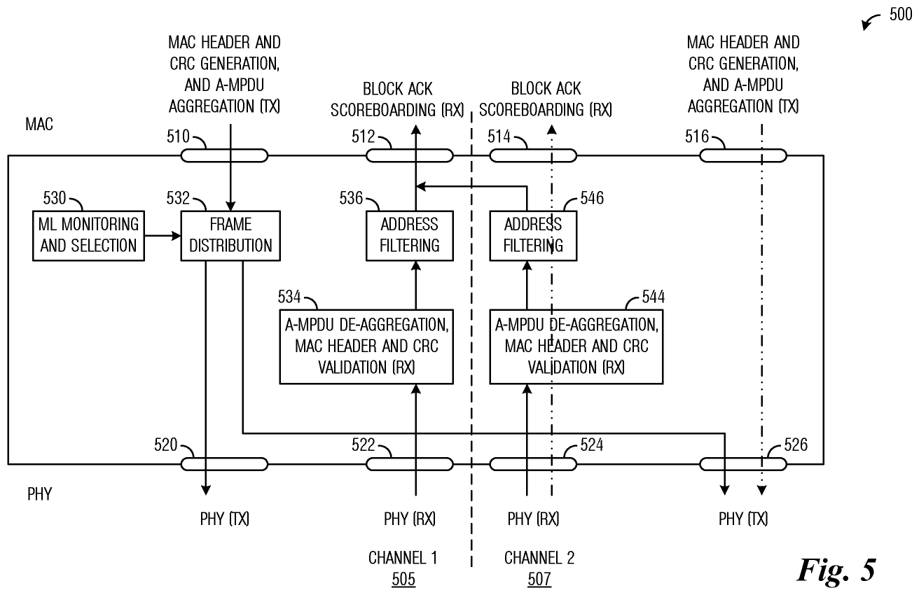

FIG. 5 illustrates a block diagram of a second example DEMUX/MUX unit 500. DEMUX/MUX unit 500 may be an example embodiment of the DEMUX/MUX units in ML-STA device 1307 and ML-STA device 2 309 of FIG. 3. As shown in FIG. 5, DEMUX/MUX unit 500 includes interface 510 interfacing with the TX path of the MAC entity of the master RCM (e.g., the MAC Header and CRC Creation and A-MPDU Aggregation unit of the MAC entity of the master RCM) for obtaining frames generated by the MAC entity of the master RCM. DEMUX/MUX unit 500 also includes interface 512 interfacing with the RX path of the MAC entity of the master RCM (e.g., the Block Ack Scoreboarding unit of the MAC entity of the master RCM) for delivering frames received by the PHY entities of the master and slave RCMs, and interfaces 520 and 526 interfacing with the TX paths of the PHY entities of the master and slave RCMs, respectively, for delivering frames to the respectively selected PHY entities for transmission. DEMUX/MUX unit 500 further includes interfaces 522 and 524 interfacing with the RX paths of the PHY entities of the master and slave RCMs, respectively, for obtaining frames received by these PHY entities, an ML Monitoring and Selection unit 530, a Frame Distribution unit 532, A-MPDU De-aggregation and MAC Header and CRC Validation units 534 and 544, and Address Filtering units 536 and 546.

DEMUX/MUX unit 500 may further include interfaces 514 and 516 interfacing with the receiving and transmitting paths of the MAC entity of the slave RCM, respectively. Interfaces 514 and 516 are not used for data of the ML traffic stream. However, if there is a concurrent traffic stream of the ML device that is configured over channel 2 507 (the slave channel) but not using channel aggregation, data of that non-ML traffic stream to be transmitted may pass through DEMUX/MUX 500 transparently via interfaces 516 and 526 (shown as the downward dot-line arrow in FIG. 5), and data of that non-ML traffic stream to be received may pass through DEMUX/MUX unit 500 transparently via interfaces 524 and 514 (shown as the upward dot-line arrow in FIG. 5). Although, only two channels, channel 1505 and channel 2507 (master channel and slave channel) are shown in FIG. 5, DEMUX/MUX unit 500 may provide the distribution and aggregation functions for more than two channels.

In an embodiment, in the transmitting direction (shown with downward solid-line arrows), a sequence of frames generated by the MAC entity (such as MAC entity 340) of the master RCM enters DEMUX/MUX unit 500 via interface 510. ML Monitoring and Selection unit 530 selects one channel (or more than one channel for redundancy purposes) from the multiple channels, over which a next frame is to be transmitted. ML Monitoring and Selection unit 530 may prioritize a frame to be the next frame in the queue to be transmitted. For example, a frame to be re-transmitted may have a higher priority to be the next frame in the queue. For another example, a frame encapsulating a higher layer response, e.g., a TCP ACK, may have a higher priority to be the next frame in the queue. Frames encapsulating a TCP ACK may be recognized by a predefined fixed size of the TCP ACK, for example. MPDU Distribution unit 532 forwards the next frame to the PHY entity of the RCM of the selected channel (such as PHY entity 360 or 362).

In an embodiment, in the receiving direction (shown with upward solid-line arrows), frames received over the multiple channels enter DEMUX/MUX unit 500 via interface 522, if received over the master channel (channel 1505), or via interface 524, if received over the slave channel (channel 2 507). Then, A-MPDU De-aggregation and MAC Header and CRC Validation units 534 and 544 perform A-MPDU and MAC header and CRC validation on the frames received over their respective channels to ensure that the frames received are valid frames. Then, Address Filtering units 536 and 546 may perform frame filtering based on the MAC address(es) in the MAC header of the received frames. For example, the frame filtering may be based on a value in the RA field in the MAC header matching the MAC address of the receiving master RCM. Alternatively, the frame filtering may be based on a value in the TA field in the MAC header matching the MAC address of the transmitting master RCM, with which the receiving master RCM has configured the channel aggregation for the ML traffic stream. Yet alternatively, the frame filtering may be based on both the RA and TA values being matched.

In an embodiment, during transmitting, when the DEMUX/MUX unit of an ML-STA device (e.g., DEMUX/MUX unit 365 of ML-STA device 1307, as shown in FIG. 3) receives a frame associated with the ML traffic stream from the MAC entity 340 of STA1320 for transmission, DEMUX/MUX unit 365 selects a channel and forwards the frame to PHY entity of the RCM operating on that channel. Frames not associated with ML traffic stream pass through the DEMUX/MUX unit and goes directly to the PHY entity of the same RCM as the MAC entity that is generating the frame. The PHY entity of that RCM adds PHY header to the frame to form PPDU for transmission.

In an embodiment, during receiving, PHY entities of STAs (e.g., PHY entities 360 and 362 of STA1320 and STA2 321, of FIG. 3) pass on frames in received PPDUs to the DEMUX/MUX unit above them. As an example, the DEMUX/MUX unit 365 of ML-STA device 1 307 filters the received frames based on the value of the RA (i.e., A1) field in the MAC header of the frame, thus forwards frames associated with the ML traffic stream to the MAC entity 340 of STA1320 for further processing (because A1 in these frames is equal to MAC_Address1). Advanced frame filtering may also use the TA (i.e., A2) field in the MAC header of the frame.

In an embodiment, a channel among the multiple channels may be configured as the master channel for serving a traffic stream of an ML-STA device and be configured as a slave channel for serving another traffic stream of the same ML-STA device or of a different ML-STA device at the same time. For example, referencing back to FIG. 3, AP1 315 of the ML-AP device 305 (using its transmitted BSS) and STA1320 of ML-STA Device 1307 form the master channel, over shared channel 1310, and AP2 317 (using its non-transmitted BSS with BSSID1) and STA2 321 (excluding its MAC entity and above) of ML-STA Device 1307 form a slave channel, over shared channel 2 312, for exchanging data of a traffic stream between the ML-AP device 305 and ML-STA Device 1307 with the ML operation. Additionally, AP2 317 of the ML-AP device 305 (using its transmitted BSS) and STA4 323 of ML-STA device 2 309 form the master channel, over shared channel 2 312, and AP1 315 of the ML-AP device 305 (using its non-transmitted BSS with BSSID2) and STA3 322 (excluding its MAC entity and above) of ML-STA device 2 309 form a slave channel, over shared channel 1310, for exchanging data of a traffic stream between the ML-AP device 305 and ML-STA device 2 309 with the ML operations.

In an embodiment, for every ML traffic stream, there is only one master channel (thus one master RCM on either side of the ML-AP and ML-STA devices) and there may be one or more slave channels (thus one or more slave RCMs on the either side). A slave RCM provides only PHY services for a portion of the data of the ML traffic stream so configured. Meanwhile, the master RCM provides PHY services for a portion of the data of the ML traffic stream, but the master RCM provides MAC services for all the data of the ML traffic stream.

Furthermore, the M-SAPs (such as M-SAPs 3345, 336, and 338) of the master RCMs serve as the interface towards higher layers. For example, the M-SAP 334 of AP1 315 of ML-AP device 305, which is designated as the master RCM for ML-STA device 307, serves as the data anchor point towards the network, for data to or from ML-STA device 307. Hence, for data of the ML traffic stream, only the MAC addresses of the master RCMs of the ML-AP and ML-STA devices are visible within the bridged network. For example, only BSSID1 (which can be used as the MAC address of AP1 315 towards the higher layers) and MAC_Address1 (of STA1 320) are included in the Ethernet frames encapsulating data of the ML traffic stream associated with ML-STA 307. BSSID2 or MAC_Address2 are not included in these Ethernet frames. Therefore, the ML operations for data transmissions at the lower layers (i.e., PHY layer and MAC sub-layer) may be invisible to the higher layers above the MAC sub-layer.

A master RCM further differs from a slave RCM in that the slave RCM provides only PHY services for some of the data of the traffic stream configured for ML operations (referred to as ML traffic stream), while the master RCM provides PHY services for some of the data and MAC services for all the data of the ML traffic stream, and the M-SAP of the master RCM serves as a data anchor point towards higher layers for all the data of the ML traffic stream. Therefore, only the MAC addresses of the master RCMs of both devices are visible within the bridged network for all the data of that ML traffic stream.

In an embodiment, MPDUs generated from the user data and management MPDUs (MMPDUs) generated from the management messages associated with the ML traffic stream may be physically transmitted or re-transmitted over any channel of the ML. When connectivity over the master channel is lost, as long as a slave channel still has connectivity, there is no need of immediately changing the master channel. Data transmissions with the ML operations involving remaining channels are still supported. Because of this, ML transmissions involving remaining channels (i.e., the slave channels) are still possible. When connectivity over the master channel is regained, data transmissions with the ML operations involving the master channel can resume smoothly without undue signaling.

FIG. 6 illustrates an example procedure 600 for configuring the ML operations. Procedure 600 involves messages exchanged between ML-AP device 605 and ML-STA device 610. ML-AP device 605 includes an RCM 606 and an RCM 607, while ML-STA device 610 includes an RCM 611 and an RCM 612. As shown in FIG. 6, ML-AP device 605 (using its RCM 606) and ML-STA device 610 (using its RCM 611) initially exchange messages in a discovery of ML capabilities, as well as establishing of an association (event 65) over a channel. As a result of the association, that channel becomes the master channel, and RCMs 606 and 611 become the master RCMs. ML-AP device 605, using master RCM 606, signals measurements and indicates a decision to add a slave channel (event 617). ML-AP device 605 (using master RCM 606) and ML-STA device 610 (using master RCM 611) exchange messages over the master channel to configure ML operations, e.g., adding a slave channel (event 619). The slave channel is configured at the ML-AP device 605 and the ML-STA device 610 (events 621 and 623), respectively.

Once a slave channel handshake (event 625) confirms that the first slave channel works, although MMPDUs (encapsulating management messages) and user data MPDUs are sent logically through the master channel, physically, the MMPDUs and user data MPDUs may be sent over either the master channel or the configured slave channel. As long as one channel (master or slave channel) remains operable, there is no need to change the channel configuration. Even if the master channel breaks down, as long as the configured slave channel is still operable, there is no need of immediately changing the master channel. Additional slave channels may be added via configuration MMPDUs sent over the operable slave channel. If connectivity over the master channel is regained at a later time, no additional signaling is needed to indicate the reestablishment of the master channel. If connectivity over the master channel cannot be regained, a re-association procedure can be performed to change the master channel. The re-association procedure may simply be a procedure used by ML-AP device 605 and ML-STA device 610 to establish an initial association in event 615, for example.

FIG. 7 illustrates an example communications system 700 highlighting the flexible aggregation of multiple channels, where an ML-STA device roams without changing master channels. Communications system 700 includes an ML-AP device 705 comprising two APs, AP1 operating over a channel (Channel 1) within 2.4 GHz band with coverage area 707 and AP2 operating over a channel (Channel 2) within 5 GHz band with coverage area 709. Communications system 700 also includes an ML-STA device 710 that is located in coverage area 707, but is outside of coverage area 709. ML-STA device 710 initially associates with AP1 of ML-AP device 705 over Channel 1, hence Channel 1 is the master channel for ML communications and AP1 is the master RCM. Although ML-STA device 710 is only communicating with ML-AP device 705 over Channel 1, both ML-AP device 705 and ML-STA device 710 are aware of their respective ML capabilities. ML-STA device 710 is mobile and moves to a location within coverage area 709 (when ML-STA device 710 is within coverage area 709, it is referred to as ML-STA device 712 to help reduce confusion). Coverage area 709 is also within coverage area 707.

As ML-STA device 712 enters coverage area 709, the ML-STA device 712 receives a signal (e.g., a Beacon) from AP2 of ML-AP device 705. Channel 2 is added as a slave channel for ML communications between ML-STA device 712 and ML-AP device 705. Channel 2 may be used to deliver a majority of data to or from ML-STA device 712 due to greater available bandwidth and lesser interference, for example. The master channel (Channel 1) remains unchanged. While within coverage area 709, ML-STA device 712 and ML-AP device 705 can communicate over both Channel 1 and Channel 2. With ML communications established, AP1 (the master RCM) is the data anchor point within communications system 700 for data of the ML traffic stream to or from the ML-STA device 712. If ML-STA device 712 leaves coverage area 709, Channel 2 may become an unsuitable for data communication. However, due to the flexible aggregation of multiple channels, there is no need to immediately perform additional signaling to establish a new association with another ML-AP device.

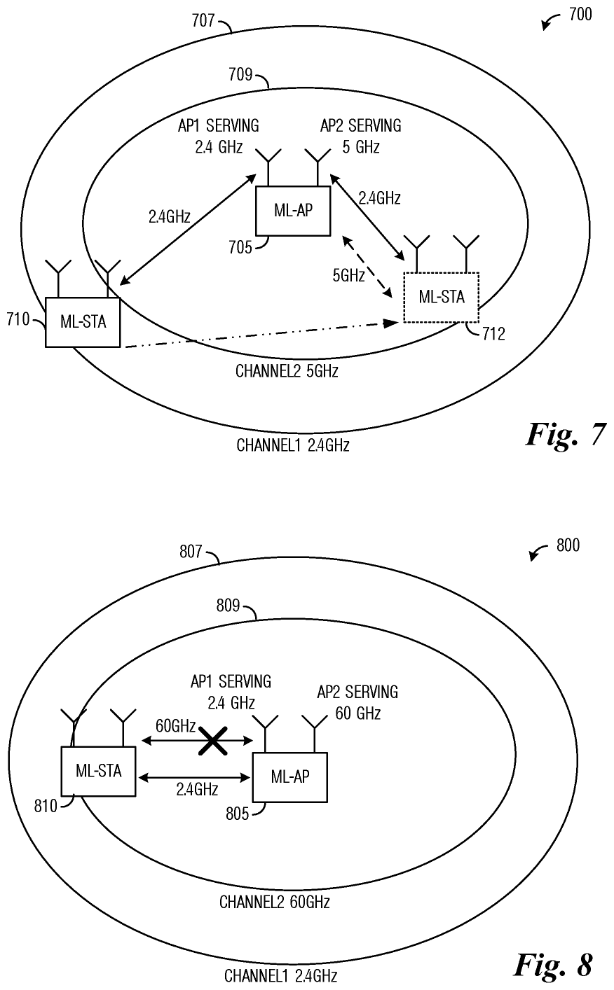

FIG. 8 illustrates an example communications system 800 highlighting the flexible aggregation of multiple channels, where service is maintained after loss of a shared channel. The lost shared channel may be either the master channel or the slave channel. In either case, service is maintained. Communications system 800 includes an ML-AP device 805 comprising two APs, AP1 operating over a channel (Channel 1) within 2.4 GHz band with coverage area 807 and AP2 operating over a channel (Channel 2) within 60 GHz band with coverage area 809. Communications system 800 also includes an ML-STA device 810 that is located within coverage area 809.

As shown in FIG. 8, ML-STA device 810 and ML-AP device 805 are initially utilizing ML communications with Channel 2 as the master channel and Channel 1 as the slave channel. However, due to a blockage or obstruction, or ML-STA device 810 moves out of coverage 809, Channel 2 becomes lost. However, due to the flexible aggregation of multiple channels, data (including MMPDUs and user data MPDUs, which together may be referred to as (M)MPDUs) to or from ML-STA device 810 may still be delivered over Channel 1 (which is the slave channel) without having to perform signaling to immediately change the master channel, master RCM, or data anchor point. If ML-STA device 810 and ML-AP device 805 have additional slave channels, the additional slave channels may also be used to deliver data to or from ML-STA device 810. At a later time, when Channel 2 (the master channel) is no longer lost (e.g., the blockage or obstruction moves away, or ML-STA device 810 moves back within coverage area 809), ML communication utilizing Channel 2 may smoothly resume, also without additional signaling.

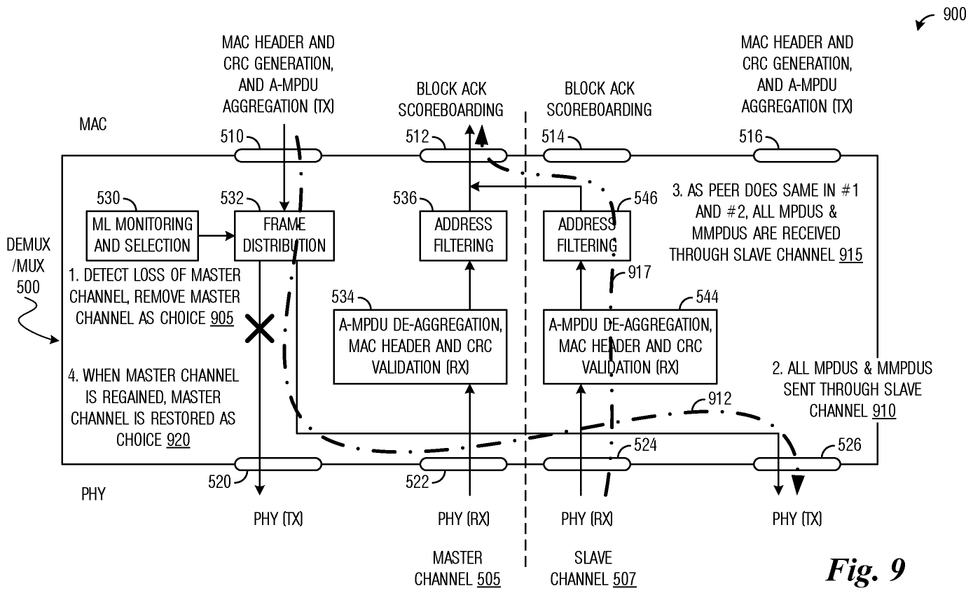

FIG. 9 illustrates a block 900 diagram of an example DEMUX/MUX unit 500 of a device, highlighting the movement of (M)MPDUs through DEMUX/MUX unit 500 resulting from a failed master channel 505. As shown in FIG. 9, at event 905, the loss of master channel 505 is detected. The detection of the loss of the master channel 505 may occur at a PHY layer entity of the master RCM associated with the master channel 505, for example. As a result of the loss of the master channel 505, ML Monitoring and Selection unit 530 removes the master channel 505 as a channel choice when selecting a shared channel over which to transmit (M)MPDUs. As an example, ML Monitoring and Selection unit 530 may set an availability bit associated with the master channel 505 to indicate that the master channel is not available. As another example, ML Monitoring and Selection unit 530 removes an entry associated with the master channel 505 from a list of available channels.

As a result of the removal of the master channel 505 as a channel choice, (M)MPDUs that would have been transmitted over the master channel are sent through a remaining shared channel. In the example shown in FIG. 9, there is only one remaining shared channel, slave channel 507. As a result, in event 910, (M)MPDUs are sent from Frame Distribution unit 532 and out interface 526 of slave channel 507 (shown in FIG. 9 as dashed dotted line 912) to the PHY entity of the device operating on slave channel 507 for the actual transmissions. In a situation where there are multiple remaining shared channels, ML Monitoring and Selection unit 530 may select one or more of the multiple remaining shared channels over which to transmit the (M)MPDUs. In an embodiment, ML Monitoring and Selection unit 530 selects the shared channel(s) based on a channel selection criterion. Examples of the channel selection criterion may include channel availability, channel lost, channel bandwidth, channel error rate, channel quality, channel performance history, channel performance restrictions, and so on.

Because master channel 505 is lost for both the device and its counterpart, (M)MPDUs received by the device from its counterpart arrive at DEMUX/MUX unit 500 of the device over slave channel 507 (event 915). The (M)MPDUs arrive from the PHY entity of the device through interface 524, A-MPDU De-aggregation and MAC Header and CRC Validation units 544, and Address Filtering unit 546. The (M)MPDUs are then passed onto the MAC entity of the device through interface 512 to begin the MAC processing, such as Block ACK scoreboarding, etc. The flow of the (M)MPDUs is shown in FIG. 9 as dashed double-dotted line 917.

When master channel 505 is regained, ML Monitoring and Selection unit 530 restores master channel 505 as a channel choice when selecting a shared channel over which to transmit (M)MPDUs (event 920). As an example, ML Monitoring and Selection unit 530 may set the availability bit associated with the master channel 505 to indicate that the master channel is available. As another example, ML Monitoring and Selection unit 530 adds an entry associated with the master channel 505 to the list of available channels.

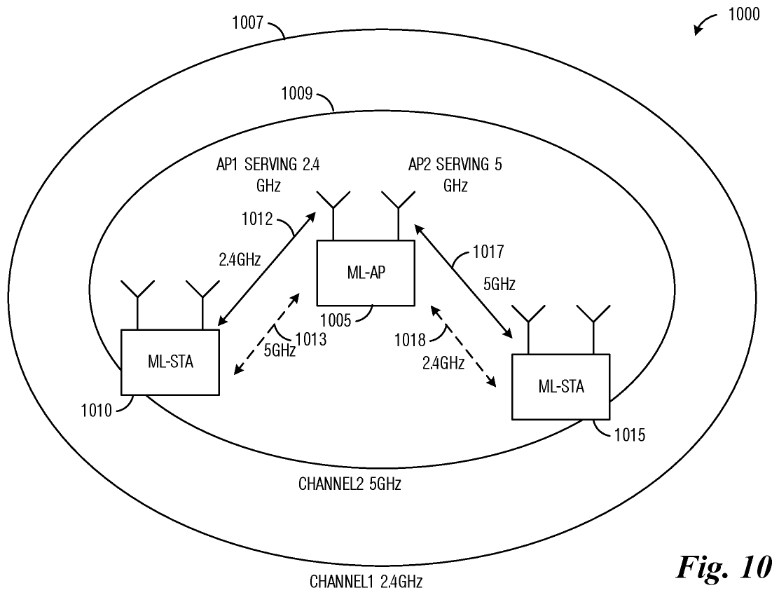

FIG. 10 illustrates an example communications system 1000 highlighting the flexible aggregation of multiple channels, where load balancing is utilized when serving ML-STA devices. Communications system 1000 includes an ML-AP device 1005 comprising two APs, AP1 operating over a channel (Channel 1) within 2.4 GHz band with coverage area 1007 and AP2 operating over a channel (Channel 2) within 5 GHz band with coverage area 1009. Communications system 1000 also includes a first ML-STA device 1010 and a second ML-STA device 1015, both in coverage area 1009.

As shown in FIG. 10, the master and slave channels for the two ML-STA devices differ, in order to balance the load on the shared channels. ML-AP device 1005 uses the 2.4 GHz channel as the master channel (channel 1012) and the 5 GHz channel as the slave channel (channel 1013) for ML-STA device 1010, while the 5 GHz channel is the master channel (channel 1017) and the 2.4 GHz channel is the slave channel (channel 1018) of ML-STA device 1015. Hence, AP1 (as the master RCM serving ML-STA device 1010) performs the MAC processing for data to or from ML-STA device 1010, while AP2 (as the master RCM serving ML-STA device 1015) performs the MAC processing for data to or from ML-STA device 1015.

In an embodiment, the load balancing may be performed in accordance with a balancing criterion. Examples of the balancing criterion may include number of data streams being processed by an RCM, an amount of data associated with the data streams being processed by an RCM, performance (such as latency, throughput, error rate, etc.) associated with an RCM, requirements of a data stream (such as quality of service (QoS) requirements, error rate requirements, latency requirements, etc.) being assigned, and so on.

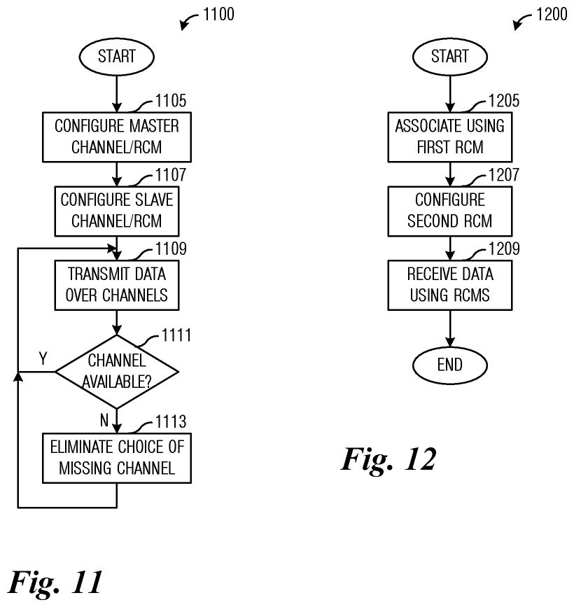

FIG. 11 illustrates a flow diagram of example operations 1100 occurring in an ML device sending data. Operations 1100 may be indicative of operations occurring in an ML device as the ML device uses the flexible aggregation of multiple channels to send data. The ML device may be an ML-AP device or an ML-STA device.

Operations 1100 begin with the ML device configuring a master channel and RCM associated therewith (block 115). As discussed previously, configuring a master channel may include the ML device performing an association and mutual authentication procedure with another ML device to configure RCMs of the ML devices. Given that both ML devices support ML operation, the channel associated with the configured RCMs of the ML devices becomes the master channel, while the configured RCMs of the ML devices become master RCMs. The RCM selected to be the master RCM may be selected based on availability. As an example, if there is one channel that is of higher quality than other channels, the RCM associated with the one channel may be selected to be the master RCM. In a situation where there are multiple suitable channels, then the channel and RCM may be selected to balance the load over the channels, for example. The ML device configures a slave channel and RCM associated therewith (block 1107). With the master channel configured, the ML device configures and adds a channel for at least one additional RCM as a slave channel. The at least one additional RCM becomes at least one additional slave RCM.

The ML device transmits data over the master channel or the slave channel (block 1109). The transmission of data may be based on availability of the master or slave channels. As an example, data may be transmitted over a first available channel (independent of the channel being a master or slave channel). As an example, data may be transmitted over a slave channel unless the master channel has been idle for an extended period of time. As an example, data may be transmitted over a channel selected based on a priority of the data, where higher priority data may be transmitted over the master channel and lower priority data may be transmitted over the slave channel.

The ML device performs a check to determine if a channel is available (block 1111). The channel may be either a master channel or a slave channel. A channel may be available if there is a transmission (with any originating device) currently occurring over the channel, which transmission can be received successfully. As an example, if an ML-STA device is able to successfully receive Beacons from an ML-AP device over a channel, the ML-STA device considers the channel to be available. A channel may be available if there has been a transmission occurring over the channel within a specified time window, which transmission can be received successfully. As an example, if an ML-STA device transmits a frame and receives an acknowledgement, then the ML-STA device considers the channel to be available. If the channel is available, the ML device continues transmitting data, if the ML device has data to transmit.

If the channel is not available, the ML device eliminates the channel as a channel choice when selecting a channel over which to transmit data (block 1113). As discussed previously, elimination of the channel as a channel choice may involve setting an availability bit associated with the channel to indicate that the channel is not available, removing an entry associated with the channel from a list of available channels, and so on. The ML device may continue to transmit data using remaining channels.

FIG. 12 illustrates a flow diagram of example operations 1200 occurring in an ML device receiving data. Operations 1200 may be indicative of operations occurring in an ML device as the ML device receives data using flexible aggregation of multiple channels. The ML device may be an ML-STA device or an ML-AP device.

Operations 1200 begin with the ML device associating with another ML device using a first RCM (block 1205). The ML devices perform an association and mutual authentication procedure using communications between first RCMs of the ML devices. Given that both ML devices support ML operation, the channel associated with the first RCMs of the ML devices becomes the master channel, while the first RCMs of the ML devices become master RCMs. The ML device configures a second RCM (block 1207). The second RCM becomes a slave RCM, controlling a slave channel. The ML device may configure the second RCM based on management messages exchanged between the first RCMs or between a pair of slave RCMs that have already been configured, for example. In a situation where there are multiple slave channels, the ML device configures multiple RCMs, with one RCM per slave channel. The ML device receives data using the RCMs (block 1209). The ML device receives data over channels associated with the RCMs.

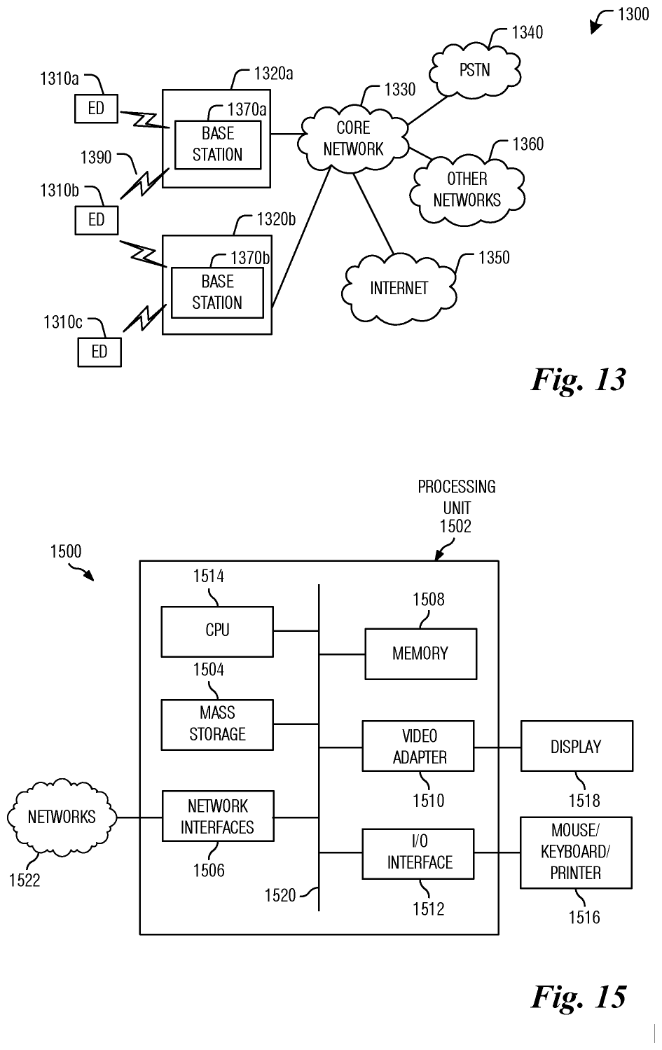

FIG. 13 illustrates an example communication system 1300. In general, the system 1300 enables multiple wireless or wired users to transmit and receive data and other content. The system 1300 may implement one or more channel access methods, such as code division multiple access (CDMA), time division multiple access (TDMA), frequency division multiple access (FDMA), orthogonal FDMA (OFDMA), single-carrier FDMA (SC-FDMA), or non-orthogonal multiple access (NOMA).

In this example, the communication system 1300 includes electronic devices (ED) 1310a-1310c, radio access networks (RANs) 1320a-1320b, a core network 1330, a public switched telephone network (PSTN) 1340, the Internet 1350, and other networks 1360. While certain numbers of these components or elements are shown in FIG. 13, any number of these components or elements may be included in the system 1300.

The EDs 1310a-1310c are configured to operate or communicate in the system 1300. For example, the EDs 1310a-1310c are configured to transmit or receive via wireless or wired communication channels. Each ED 1310a-1310c represents any suitable end user device and may include such devices (or may be referred to) as a user equipment or device (UE), wireless transmit or receive unit (WTRU), mobile station, fixed or mobile subscriber unit, cellular telephone, personal digital assistant (PDA), smartphone, laptop, computer, touchpad, wireless sensor, or consumer electronics device.

The RANs 1320a-1320b here include base stations 1370a-1370b, respectively. Each base station 1370a-1370b is configured to wirelessly interface with one or more of the EDs 1310a-1310c to enable access to the core network 1330, the PSTN 1340, the Internet 1350, or the other networks 1360. For example, the base stations 1370a-1370b may include (or be) one or more of several well-known devices, such as a base transceiver station (BTS), a Node-B (NodeB), an evolved NodeB (eNodeB), a Next Generation (NG) NodeB (gNB), a Home NodeB, a Home eNodeB, a site controller, an access point (AP), or a wireless router. The EDs 1310a-1310c are configured to interface and communicate with the Internet 1350 and may access the core network 1330, the PSTN 1340, or the other networks 1360.

In the embodiment shown in FIG. 13, the base station 1370a forms part of the RAN 1320a, which may include other base stations, elements, or devices. Also, the base station 1370b forms part of the RAN 1320b, which may include other base stations, elements, or devices. Each base station 1370a-1370b operates to transmit or receive wireless signals within a particular geographic region or area, sometimes referred to as a “cell.” In some embodiments, multiple-input multiple-output (MIMO) technology may be employed having multiple transceivers for each cell.

The base stations 1370a-1370b communicate with one or more of the EDs 1310a-1310c over one or more air interfaces 1390 using wireless communication links. The air interfaces 1390 may utilize any suitable radio access technology.

It is contemplated that the system 1300 may use multiple channel access functionality, including such schemes as described above. In particular embodiments, the base stations and EDs implement 5G New Radio (NR), LTE, LTE-A, or LTE-B. Of course, other multiple access schemes and wireless protocols may be utilized.

The RANs 1320a-1320b are in communication with the core network 1330 to provide the EDs 1310a-1310c with voice, data, application, Voice over Internet Protocol (VoIP), or other services. Understandably, the RANs 1320a-1320b or the core network 1330 may be in direct or indirect communication with one or more other RANs (not shown). The core network 1330 may also serve as a gateway access for other networks (such as the PSTN 1340, the Internet 1350, and the other networks 1360). In addition, some or all of the EDs 1310a-1310c may include functionality for communicating with different wireless networks over different wireless links using different wireless technologies or protocols. Instead of wireless communication (or in addition thereto), the EDs may communicate via wired communication channels to a service provider or switch (not shown), and to the Internet 1350.

Although FIG. 13 illustrates one example of a communication system, various changes may be made to FIG. 13. For example, the communication system 1300 could include any number of EDs, base stations, networks, or other components in any suitable configuration.

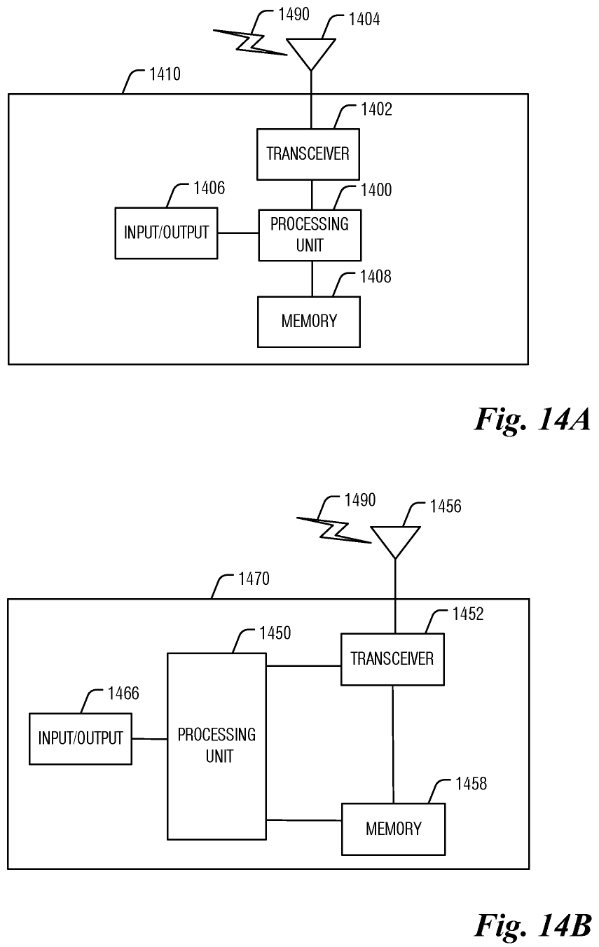

FIGS. 14A and 14B illustrate example devices that may implement the methods and teachings according to this disclosure. In particular, FIG. 14A illustrates an example ED 1410, and FIG. 14B illustrates an example base station 1470. These components could be used in the system 1300 or in any other suitable system.

As shown in FIG. 4A, the ED 1410 includes at least one processing unit 1400. The processing unit 1400 implements various processing operations of the ED 1410. For example, the processing unit 1400 could perform signal coding, data processing, power control, input/output processing, or any other functionality enabling the ED 1410 to operate in the system 1300. The processing unit 1400 also supports the methods and teachings described in more detail above. Each processing unit 1400 includes any suitable processing or computing device configured to perform one or more operations. Each processing unit 1400 could, for example, include a microprocessor, microcontroller, digital signal processor, field programmable gate array, or application specific integrated circuit.

The ED 1410 also includes at least one transceiver 1402. The transceiver 1402 is configured to modulate data or other content for transmission by at least one antenna or NIC (Network Interface Controller) 1404. The transceiver 1402 is also configured to demodulate data or other content received by the at least one antenna 1404. Each transceiver 1402 includes any suitable structure for generating signals for wireless or wired transmission or processing signals received wirelessly or by wire. Each antenna 1404 includes any suitable structure for transmitting or receiving wireless or wired signals. One or multiple transceivers 1402 could be used in the ED 1410, and one or multiple antennas 1404 could be used in the ED 1410. Although shown as a single functional unit, a transceiver 1402 could also be implemented using at least one transmitter and at least one separate receiver.

The ED 1410 further includes one or more input/output devices 1406 or interfaces (such as a wired interface to the Internet 1350). The input/output devices 1406 facilitate interaction with a user or other devices (network communications) in the network. Each input/output device 1406 includes any suitable structure for providing information to or receiving information from a user, such as a speaker, microphone, keypad, keyboard, display, or touch screen, including network interface communications.

In addition, the ED 410 includes at least one memory 408. The memory 48 stores instructions and data used, generated, or collected by the ED 1410. For example, the memory 1408 could store software or firmware instructions executed by the processing unit(s) 1400 and data used to reduce or eliminate interference in incoming signals. Each memory 408 includes any suitable volatile or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

As shown in FIG. 14B, the base station 1470 includes at least one processing unit 1450, at least one transceiver 1452, which includes functionality for a transmitter and a receiver, one or more antennas 1456, at least one memory 1458, and one or more input/output devices or interfaces 1466. A scheduler, which would be understood by one skilled in the art, is coupled to the processing unit 1450. The scheduler could be included within or operated separately from the base station 1470. The processing unit 1450 implements various processing operations of the base station 1470, such as signal coding, data processing, power control, input/output processing, or any other functionality. The processing unit 1450 can also support the methods and teachings described in more detail above. Each processing unit 1450 includes any suitable processing or computing device configured to perform one or more operations. Each processing unit 1450 could, for example, include a microprocessor, microcontroller, digital signal processor, field programmable gate array, or application specific integrated circuit.

Each transceiver 1452 includes any suitable structure for generating signals for wireless or wired transmission to one or more EDs or other devices. Each transceiver 1452 further includes any suitable structure for processing signals received wirelessly or by wire from one or more EDs or other devices. Although shown combined as a transceiver 1452, a transmitter and a receiver could be separate components. Each antenna 1456 includes any suitable structure for transmitting or receiving wireless or wired signals. While a common antenna 1456 is shown here as being coupled to the transceiver 1452, one or more antennas 1456 could be coupled to the transceiver(s) 1452, allowing separate antennas 1456 to be coupled to the transmitter and the receiver if equipped as separate components. Each memory 1458 includes any suitable volatile or non-volatile storage and retrieval device(s). Each input/output device 1466 facilitates interaction with a user or other devices (network communications) in the network. Each input/output device 1466 includes any suitable structure for providing information to or receiving/providing information from a user, including network interface communications.

FIG. 15 is a block diagram of a computing system 1500 that may be used for implementing the devices and methods disclosed herein. For example, the computing system can be any entity of UE, access network (AN), mobility management (MM), session management (SM), user plane gateway (UPGW), or access stratum (AS). Specific devices may utilize all of the components shown or only a subset of the components, and levels of integration may vary from device to device. Furthermore, a device may contain multiple instances of a component, such as multiple processing units, processors, memories, transmitters, receivers, etc. The computing system 1500 includes a processing unit 1502. The processing unit includes a central processing unit (CPU) 1514, memory 1508, and may further include a mass storage device 1504, a video adapter 1510, and an I/O interface 1512 connected to a bus 1520.

The bus 1520 may be one or more of any type of several bus architectures including a memory bus or memory controller, a peripheral bus, or a video bus. The CPU 1514 may comprise any type of electronic data processor. The memory 1508 may comprise any type of non-transitory system memory such as static random access memory (SRAM), dynamic random access memory (DRAM), synchronous DRAM (SDRAM), read-only memory (ROM), or a combination thereof. In an embodiment, the memory 1508 may include ROM for use at boot-up, and DRAM for program and data storage for use while executing programs.

The mass storage 1504 may comprise any type of non-transitory storage device configured to store data, programs, and other information and to make the data, programs, and other information accessible via the bus 1520. The mass storage 1504 may comprise, for example, one or more of a solid state drive, hard disk drive, a magnetic disk drive, or an optical disk drive.

The video adapter 1510 and the I/O interface 1512 provide interfaces to couple external input and output devices to the processing unit 1502. As illustrated, examples of input and output devices include a display 1518 coupled to the video adapter 1510 and a mouse, keyboard, or printer 1516 coupled to the I/O interface 1512. Other devices may be coupled to the processing unit 1502, and additional or fewer interface cards may be utilized. For example, a serial interface such as Universal Serial Bus (USB) (not shown) may be used to provide an interface for an external device.

The processing unit 1502 also includes one or more network interfaces 1506, which may comprise wired links, such as an Ethernet cable, or wireless links to access nodes or different networks. The network interfaces 1506 allow the processing unit 1502 to communicate with remote units via the networks. For example, the network interfaces 1506 may provide wireless communication via one or more transmitters/transmit antennas and one or more receivers/receive antennas. In an embodiment, the processing unit 1502 is coupled to a local-area network 1522 or a wide-area network for data processing and communications with remote devices, such as other processing units, the Internet, or remote storage facilities.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. Other steps may be performed by a configuring unit or module, an associating unit or module, an obtaining unit or module, a delivering unit or module, or a determining unit or module. The respective units or modules may be hardware, software, or a combination thereof. For instance, one or more of the units or modules may be an integrated circuit, such as field programmable gate arrays (FPGAs) or application-specific integrated circuits (ASICs).

Although the present disclosure and its advantages have been described in detail, it should be understood that various changes, substitutions and alterations can be made herein without departing from the scope of the disclosure as defined by the appended claims.

1. A method implemented by an access point (AP), the method comprising:
configuring, by the AP, a first radio communications module (RCM) of the AP to serve a first transmitted basic service set (BSS) using a first BSS identifier (BSSID) and to serve a first non-transmitted BSS using a second BSSID, the second BSSID being different from the first BSSID, and the first RCM operating in a first shared channel;
configuring, by the AP, a second RCM of the AP to serve a second transmitted BSS using the second BSSID and to serve a second non-transmitted BSS using the first BSSID, the second RCM operating in a second shared channel, the second shared channel and the first shared channel operating on different radio frequency carriers; and
transmitting, by the AP, to a first station, a first set of data, a first subset of the first set of data being encapsulated in a first set of frames, the first set of frames being transmitted using the first RCM over the first shared channel, and a second subset of the first set of data being encapsulated in a second set of frames, the second set of frames being transmitted using the second RCM over the second shared channel.

2. The method of claim 1, further comprising:
determining, by the AP, that the first shared channel is unavailable; and
transmitting, by the AP, to the first station, a second set of data using the second RCM over the second shared channel based on the first shared channel being unavailable.

3. The method of claim 2, further comprising:
determining, by the AP, that the first shared channel is available; and
transmitting, by the AP, to the first station, a first subset of a third set of data using the first RCM over the first shared channel, and a second subset of the third set of data using the second RCM over the second shared channel based on the first shared channel being available.

4. The method of claim 1, further comprising:
obtaining, by the AP, the first set of data from a first higher layer entity through a first media access control (MAC) service access point (M-SAP) of the first RCM, the first higher layer entity being above a first MAC entity of the first RCM and associated with the AP.

5. The method of claim 4, further comprising:
generating, by the AP using the first MAC entity, the first set of frames to encapsulate the first subset of the first set of data and the second set of frames to encapsulate the second subset of the first set of data.

6. The method of claim 1, each frame of the first set of frames and the second set of frames comprising a first MAC address of the first station in a receiver address (RA) field and the first BSSID in a transmitter address (TA) field.

7. The method of claim 4, further comprising:
receiving, by the AP, from the first station, a fourth set of data, a first subset of the fourth set of data being encapsulated in a third set of frames, the third set of frames being received using the first RCM over the first shared channel, and a second subset of the fourth set of data being encapsulated in a fourth set of frames, the fourth set of frames being received using the second RCM over the second shared channel.

8. The method of claim 7, further comprising:
processing, by the AP using the first MAC entity, the third set of frames and the fourth set of frames to recover the fourth set of data.

9. The method of claim 8, further comprising:
delivering, by the AP, the fourth set of data to the first higher layer entity through the first M-SAP.

10. The method of claim 7, each frame of the third set of frames and the fourth set of frames comprising the first BSSID in a RA field and a first MAC address of the first station in a TA field.

11. The method of claim 1, further comprising:
transmitting, by the AP, to a second station, a fifth set of data, a first subset of the fifth set of data being encapsulated in a fifth set of frames, the fifth set of frames being transmitted using the first RCM over the first shared channel, and a second subset of the fifth set of data being encapsulated in a sixth set of frames, the sixth set of frames being transmitted using the second RCM over the second shared channel; and
receiving, by the AP, from the second station, a sixth set of data, a first subset of the sixth set of data being encapsulated in a seventh set of frames, the seventh set of frames being received using the first RCM over the first shared channel, and a second subset of the sixth set of data being encapsulated in an eighth set of frames, the eighth set of frames being received using the second RCM over the second shared channel.

12. The method of claim 11, further comprising:
obtaining, by the AP, the fifth set of data from a second higher layer entity through a second M-SAP of the second RCM, the second higher layer entity being above a second MAC entity of the second RCM and associated with the AP; and
generating, by the AP using the second MAC entity, the fifth set of frames to encapsulate the first subset of the fifth set of data and the sixth set of frames to encapsulate the second subset of the fifth set of data.

13. The method of claim 12, further comprising:
processing, by the AP using the second MAC entity, the seventh set of frames and the eighth set of frames to recover the sixth set of data; and
delivering, by the AP, the sixth set of data to the second higher layer entity through the second M-SAP.

14. The method of claim 11, each frame of the fifth set of frames and the sixth set of frames comprising a second MAC address of the second station in an RA field and the second BSSID in the TA field, and each frame of the seventh set of frames and the eighth set of frames comprising the second BSSID in an RA field and the second MAC address of the second station in the TA field.

15. A method implemented by a station, the method comprising:
associating, by the station, with a transmitted basic service set (BSS) of an access point (AP) using a first radio communications module (RCM) of the station, the transmitted BSS being identified by a transmitted BSS identifier (BSSID), and the first RCM operating in a first shared channel;
communicating, by the station, with the AP using the first RCM, to configure a second RCM of the station, the second RCM operating in a second shared channel, the second shared channel and the first shared channel operating on different radio frequency carriers;
transmitting, by the station, to the AP, a first set of data, a first subset of the first set of data being encapsulated in a first set of frames, the first set of frames being transmitted using the first RCM over the first shared channel, and a second subset of the first set of data being encapsulated in a second set of frames, the second set of frames being transmitted using the second RCM over the second shared channel; and
receiving, by the station, from the AP, a second set of data, a first subset of the second set of data being encapsulated in a third set of frames, the third set of frames being received using the first RCM over the first shared channel, and a second subset of the second set of data being encapsulated in a fourth set of frames, the fourth set of frames being received using the second RCM over the second shared channel.

16. The method of claim 15, further comprising:
obtaining, by the station, the first set of data from a higher layer entity of the station through a media access control (MAC) service access point (M-SAP) of the first RCM; and
generating, by the station using a MAC entity of the first RCM, the first set of frames to encapsulate the first subset of the first set of data and the second set of frames to encapsulate the second subset of the first set of data.

17. The method of claim 16, further comprising:
processing, by the station using the MAC entity of the first RCM, the third set of frames and the fourth set of frames to recover the second set of data; and
delivering, by the station, the second set of data to the higher layer entity through the M-SAP of the first RCM.

18. The method of claim 17, each frame of the first set of frames and the second set of frames comprising a MAC address of the station in a receiver address (RA) field and the transmitted BSSID in a transmitter address (TA) field, and each frame of the third set of frames and the fourth set of frames comprising the transmitted BSSID in the RA field and the MAC address of the station in the TA field.

19. An access point (AP) comprising:
a non-transitory memory storage comprising instructions; and
one or more processors in communication with the non-transitory memory storage, the one or more processors executing the instructions to cause the AP to:
configure a first radio communications module (RCM) of the AP to serve a first transmitted basic service set (BSS) using a first BSS identifier (BSSID) and to serve a first non-transmitted BSS using a second BSSID, the second BSSID being different from the first BSSID, and the first RCM operating in a first shared channel,
configure a second RCM of the AP to serve a second transmitted BSS using the second BSSID and to serve a second non-transmitted BSS using the first BSSID, the second RCM operating in a second shared channel, the second shared channel and the first shared channel operating on different radio frequency carriers, and
transmit, to a first station, a first set of data, a first subset of the first set of data being encapsulated in a first set of frames, the first set of frames being transmitted using the first RCM over the first shared channel, and a second subset of the first set of data being encapsulated in a second set of frames, the second set of frames being transmitted using the second RCM over the second shared channel.

20. The AP of claim 19, the one or more processors further executing the instructions to cause the AP to:
determine that the first shared channel is unavailable,
transmit, to the first station, a second set of data using the second RCM over the second shared channel based on the first shared channel being unavailable.

21. The AP of claim 20, the one or more processors further executing the instructions to cause the AP to;
determine that the first shared channel is available, and
transmit, to the first station, a first subset of a third set of data using the first RCM over the first shared channel, and a second subset of the third set of data using the second RCM over the second shared channel based on the first shared channel being available.

22. The AP of anyone of claim 19, the one or more processors further executing the instructions to cause the AP to:
obtain the first set of data from a first higher layer entity through a first media access control (MAC) service access point (M-SAP) of the first RCM, the first higher layer entity being above a first MAC entity of the first RCM and associated with the AP.

23. The AP of claim 22, the one or more processors further executing the instructions to cause the AP to:
receive, from the first station, a fourth set of data, a first subset of the fourth set of data being encapsulated in a third set of frames, the third set of frames being received using the first RCM over the first shared channel, and a second subset of the fourth set of data being encapsulated in a fourth set of frames, the fourth set of frames being received using the second RCM over the second shared channel.

24. The AP of claim 19, the one or more processors further executing the instructions to cause the AP to:
transmit, to a second station, a fifth set of data, a first subset of the fifth set of data being encapsulated in a fifth set of frames, the fifth set of frames being transmitted using the first RCM over the first shared channel, and a second subset of the fifth set of data being encapsulated in a sixth set of frames, the sixth set of frames being transmitted using the second RCM over the second shared channel, and receive, from the second station, a sixth set of data, a first subset of the sixth set of data being encapsulated in a seventh set of frames, the seventh set of frames being received using the first RCM over the first shared channel, and a second subset of the sixth set of data being encapsulated in an eighth set of frames, the eighth set of frames being received using the second RCM over the second shared channel.

25. The AP of claim 24, the one or more processors further executing the instructions to cause the AP to:
obtain the fifth set of data from a second higher layer entity through a second M-SAP of the second RCM, the second higher layer entity being above a second MAC entity of the second RCM and associated with the AP, and
generate, using the second MAC entity, the fifth set of frames to encapsulate the first subset of the fifth set of data and the sixth set of frames to encapsulate the second subset of the fifth set of data.

26. The AP of claim 25, the one or more processors further executing the instructions to cause the AP to
process, using the second MAC entity, the seventh set of frames and the eighth set of frames to recover the sixth set of data, and deliver the sixth set of data to the second higher layer entity through the second M-SAP.

27. A station comprising:
a non-transitory memory storage comprising instructions; and
one or more processors in communication with the non-transitory memory storage, the one or more processors executing the instructions to cause the station to:
associate with a transmitted basic service set (BSS) of an access point (AP) using a first radio communications module (RCM) of the station, the transmitted BSS being identified by a transmitted BSS identifier (BSSID), and the first RCM operating in a first shared channel,
communicate, with the AP using the first RCM, to configure a second RCM of the station, the second RCM operating in a second shared channel, the second shared channel and the first shared channel operating on different radio frequency carriers,
transmit, to the AP, a first set of data, a first subset of the first set of data being encapsulated in a first set of frames, the first set of frames being transmitted using the first RCM over the first shared channel, and a second subset of the first set of data being encapsulated in a second set of frames, the second set of frames being transmitted using the second RCM over the second shared channel, and
receive, from the AP, a second set of data, a first subset of the second set of data being encapsulated in a third set of frames, the third set of frames being received using the first RCM over the first shared channel, and a second subset of the second set of data being encapsulated in a fourth set of frames, the fourth set of frames being received using the second RCM over the second shared channel.

28. The station of claim 27, the one or more processors further executing the instructions to cause the station to:
obtain the first set of data from a higher layer entity of the station through a media access control (MAC) service access point (M-SAP) of the first RCM, and generate, using a MAC entity of the first RCM, the first set of frames to encapsulate the first subset of the first set of data and the second set of frames to encapsulate the second subset of the first set of data.

29. The station of claim 28, the one or more processors further executing the instructions to cause the station to:
process, using the MAC entity of the first RCM, the third set of frames and the fourth set of frames to recover the second set of data, and deliver the second set of data to the higher layer entity through the M-SAP of the first RCM.

30. The station of claim 29, each frame of the first set of frames and the second set of frames comprising a MAC address of the station in a receiver address (RA) field and the transmitted BSSID in a transmitter address (TA) field, and each frame of the third set of frames and the fourth set of frames comprising the transmitted BSSID in the RA field and the MAC address of the station in the TA field.
